(19) United States
(12) Patent Application Publication
(10) Pub. No.: US 2026/0095530 A1
(43) Pub. Date: Apr. 2, 2026

(54) IMAGE PROCESSING APPARATUS, IMAGE PROCESSING METHOD, AND NON-TRANSITORY COMPUTER READABLE RECORDING MEDIUM

(71) Applicant: MIMAKI ENGINEERING CO., LTD., Nagano (JP)

(72) Inventor: Kazuma Nakahara, Nagano (JP)

(73) Assignee: MIMAKI ENGINEERING CO., LTD., Nagano (JP)

(21) Appl. No.: 19/336,527

(22) Filed: Sep. 23, 2025

(30) Foreign Application Priority Data
Sep. 27, 2024 (JP) 2024-168692

(51) Int. Cl. H04N 1/00; H04N 1/60

(52) U.S. Cl. CPC H04N 1/00456; H04N 1/00567; H04N 1/6088

(57) ABSTRACT

A control unit of an image processing apparatus executes a preview screen display process of causing a display unit to display a design editing screen (a preview screen for image data). The design editing screen includes a preview area, an object list, and a processing input unit. The preview area displays a preview of objects constituting the image data. The object list displays information on each of the objects in a list format. Input processing content can be input into the processing input unit for each of the objects.

### CROSS REFERENCE TO RELATED APPLICATIONS

This application claims the priority benefit of Japanese Patent Application No. 2024-168692, filed on September 27 2024. The entirety of the above-mentioned patent application is hereby incorporated by reference herein and made a part of this specification.

### TECHNICAL FIELD

The present disclosure relates to an image processing apparatus, an image processing method, and a non-transitory computer readable recording medium.

### DESCRIPTION OF THE BACKGROUND ART

An image processing apparatus generates image data to be output to an image forming apparatus such as a printer. The image forming apparatus may include a printer that forms an image by printing, a cutting plotter that forms an image by cutting, and the like.

When an object to be printed by the printer and an object to be cut by the cutting plotter are mixed in the same image data, the image processing apparatus generates and outputs image data in accordance with the specifications of each of the printer and the cutting plotter (e.g., see Japanese Unexamined Patent Publication No. 2020-123241).

### SUMMARY

A user needs to set processing content, such as printing or cutting, for each object. Here, when a setting screen for processing content for an object has been provided as a separate screen from a preview screen, the user needs to transition the screen for each object to set the processing content, and the work becomes complicated.

In an image processing apparatus, there is a need to display a screen on which processing content for the object constituting image data can be easily set.

An image processing apparatus according to an aspect the present disclosure is:
(1) an image processing apparatus that generates image data outputtable to an image forming apparatus, the image processing apparatus including
   a control unit that controls a screen caused to be displayed on a display unit in accordance with an operation input by a user via an operation unit,
   in which
   the control unit executes a preview screen display process of causing the display unit to display a preview screen for the image data, and
   the preview screen includes
   a preview area that displays a preview of each of objects constituting the image data,
   an object list that displays information on each of the objects in a list format, and
   a processing input unit configured to allow processing content to be input for each of the objects.
(2) In the image processing apparatus according to (1) above,
   the image forming apparatus includes a plurality of image forming apparatuses capable of executing different processes,
   the processing input unit is configured to receive, for each object, processing content executable by each of the plurality of image forming apparatuses, and
   the control unit executes an image data output process in which image data is generated for each processing content input to the processing input unit, and the image data is output to the image forming apparatus capable of executing the corresponding processing content.
(3) In the image processing apparatus according to (1) or (2) above, the processing input unit is configured to receive input of a process for displaying or hiding each of the objects in the preview area.
(4) In the image processing apparatus according to any one of (1) to (3) above,
   the image forming apparatus includes an apparatus that forms an image by cutting, and
   when the cutting is input as the processing content, the processing input unit is configured to receive input of a cutting member for use in the cutting.
(5) In the image processing apparatus according to any one of (1) to (4) above,
   the image forming apparatus includes an apparatus that forms an image by printing, and
   the control unit causes a display mode in the preview area to differ between an object for which the printing has been input as the processing content into the processing input unit and an object for which the cutting has been input.
(6) In the image processing apparatus according to any one of (1) to (5) above, the control unit displays the object for which the cutting has been input as the processing content into the processing input unit with a cut line in the preview area.
(7) In the image processing apparatus according to any one of (1) to (6) above, the control unit changes a display color in the preview area for the object for which the cutting has been input as the processing content into the processing input unit.
(8) In the image processing apparatus according to any one of (1) to (7) above, in the preview screen display process, when the user selects one of the objects displayed in the preview area, the control unit changes display of the selected object in the object list.
(9) In the image processing apparatus according to any one of (1) to (8) above, in the preview screen display process, when the user selects one of the objects displayed in the object list, the control unit changes display of the selected object in the preview area.
(10) In the image processing apparatus in accordance with any one of (1) to (9) above, in response to a request from the user, the control unit executes a filtering process of causing only objects, for which the same processing content has been input into the processing input unit, to be displayed in the object list.
(11) In the image processing apparatus according to any one of (1) to (10) above, in the filtering process, the control unit causes only filtered objects to be displayed in the preview area.
(12) In the image processing apparatus according to any one of (1) to (11) above, the processing input unit is configured to allow the same processing content to be collectively input for a plurality of the objects.
(13) In the image processing apparatus according to any one of (1) to (12) above, the objects for which the same processing content is to be collectively input are selectable in at least one of the object list or the preview area.

An image processing method according to an aspect of the present disclosure is:
(14) an image processing method performed by an image processing apparatus that generates image data outputtable to an image forming apparatus,
   in which
   the image forming apparatus includes a control unit that controls a screen caused to be displayed on a display unit in accordance with an operation input by a user via an operation unit,
   the control unit executes a preview screen display process of causing the display unit to display a preview screen for the image data,
   the preview screen includes
   a preview area that displays a preview of each of objects constituting the image data,
   an object list that displays information on each of the objects in a list format, and
   a processing input unit configured to allow processing content to be input for each of the objects.

A non-transitory computer readable recording medium according to an aspect of the present disclosure stores:
(15) a program that implements a function of an image processing apparatus that generates image data outputtable to an image forming apparatus, the program causing
   an electronic device to function as a control unit that controls a screen caused to be displayed on a display unit in accordance with an operation input by a user via an operation unit, and
   the control unit to execute a preview screen display process of causing the display unit to display a preview screen for the image data,
   in which the preview screen includes
   a preview area that displays a preview of each of objects constituting the image data,
   an object list that displays information on each of the objects in a list format, and
   a processing input unit configured to allow processing content to be input for each of the objects.

According to the present disclosure, the user can easily set processing content for each of the objects constituting the image data from the preview screen.

### BRIEF DESCRIPTION OF THE DRAWINGS

FIG. 1 is a diagram illustrating an image processing apparatus according to an embodiment.

FIG. 2 is a diagram illustrating a screen that a control unit causes a display unit to display, in a flow until image data is output.

FIG. 3 is a view illustrating an example of a home screen.

FIG. 4A and FIG. 4B are views for explaining highlighting.

FIG. 5A and FIG. 5B are views for explaining a pickup display.

FIG. 6 is a view illustrating an example of a design editing screen.

FIG. 7A is a view for explaining a change in display of an object list when an object in the preview area is selected, and FIG. 7B is a view for explaining a change in display of a preview area when an object in the object list is selected.

FIG. 8A is a view for explaining a processing input unit, and FIG. 8B is a view illustrating a variation of the processing input unit.

FIG. 9 is a view illustrating a display mode of an object in accordance with processing content set by the processing input unit.

FIG. 10 is a view illustrating a collective input unit.

FIG. 11 is a view illustrating an example of a design placement form editing screen.

FIG. 12 is a view illustrating an example of a form editing screen.

FIG. 13 is a view illustrating an example of an output setting screen.

FIG. 14A to FIG. 14C are views illustrating a specific example of a mark adding process of the control unit.

FIG. 15A and FIG. 15B are views illustrating an example of the layout adjustment of the control unit.

FIG. 16 is a view for explaining another example of the layout adjustment.

FIG. 17A and FIG. 17B are views for explaining layout adjustment in accordance with the length of a printing area.

FIG. 18 is a diagram illustrating a hardware configuration of an electronic device constituting the image processing apparatus.

### DETAILED DESCRIPTION OF EMBODIMENTS

Hereinafter, an embodiment of the present disclosure will be described with reference to the drawings.

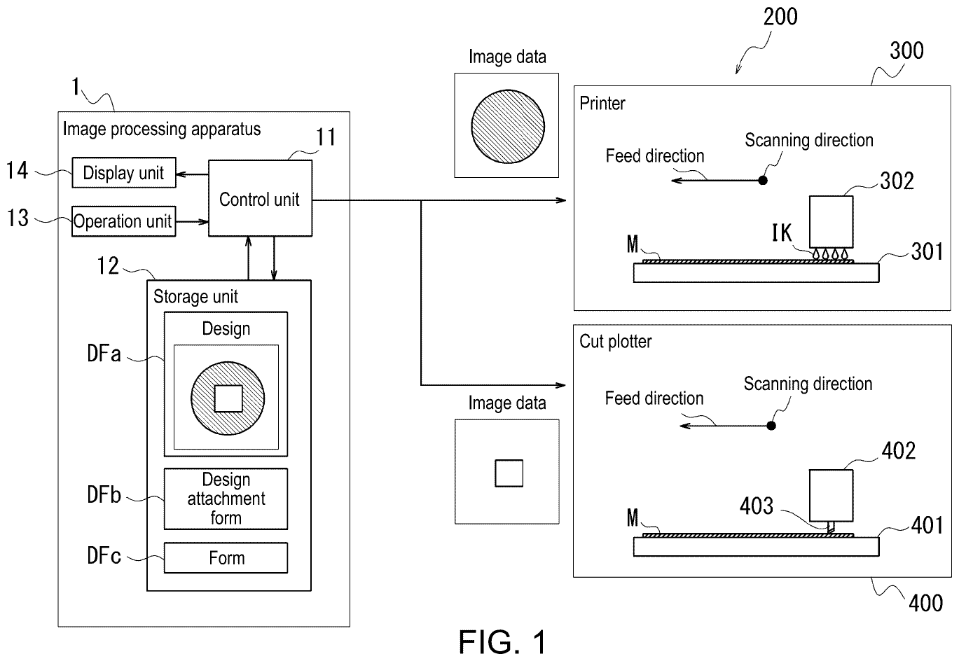

FIG. 1 is a diagram illustrating an image processing apparatus 1 according to an embodiment.

As illustrated in FIG. 1, the image processing apparatus 1 generates image data that can be output to an image forming apparatus 200.

The image forming apparatus 200 is an apparatus that performs an image forming process on a medium M.

The image forming apparatus 200 can include, for example, a printer 300 that forms an image by printing, a cutting plotter 400 that forms an image by cutting, and the like.

The printer 300 can be, for example, an inkjet printer that ejects ink IK onto the medium M to perform printing.

The printer 300 includes, for example, a platen 301 that supports the medium M and a head 302 that ejects ink IK. The head 302 is provided to face the platen 301. The head 302 performs printing by ejecting the ink IK while moving in a scanning direction and a feed direction relative to the medium M supported by the platen 301.

In FIG. 1, the direction from the front side to the back side of the figure corresponds to the scanning direction, and the left-right direction in the figure corresponds to the feed direction (medium transport direction).

Note that the movement of the head 302 with respect to the medium M may be relative. Therefore, the platen 301 may be moved instead of the head 302, or the medium M may be moved on the platen 301.

The cutting plotter 400 includes, for example, a platen 401 that supports the medium M and a head 402 that holds a cutting member 403. The head 402 is provided to face the platen 401. The head 402 cuts the medium M with the cutting member 403 while moving in the scanning direction and the feed direction relative to the medium M supported by the platen 401.

The cutting plotter 400 can perform cutting in various modes by switching the cutting member 403 such as a cutter, a pen, or a roller.

Note that the image forming apparatus 200 may be capable of both printing and cutting.

The medium M on which the image forming apparatus 200 forms an image can be made of, for example, a synthetic resin such as acrylic, vinyl chloride, or polyester, paper, cloth (fabric, nonwoven fabric), wood, ceramics, metal, food, leather, or the like.

The image processing apparatus 1 generates and outputs image data to the image forming apparatus 200 in a format (e.g., JPEG, PDF, vector data, etc.) in accordance with the specifications of each image forming apparatus.

Here, a plurality of image forming apparatuses 200 may perform processes on the same medium M to generate one printed matter. For example, FIG. 1 illustrates a printed matter having a design in which the center of a color circle is cut into a rectangle. In the case of generating this printed matter, first, a color circle is printed on the medium M by the printer 300. Thereafter, the medium M is transferred from the printer 300 to the cutting plotter 400, and the center of the circle printed on the medium M is cut into a rectangle.

In addition, printing can be performed on the medium M, which has been printed by one printer 300, by another printer 300 to generate one printed matter.

When processes are performed by a plurality of image forming apparatuses 200 to generate one printed matter as described above, the image processing apparatus 1 needs to generate image data in accordance with each of the processes performed by the respective image forming apparatuses 200. In the design of FIG. 1, the image processing apparatus 1 generates and outputs image data (JPEG, PDF, etc.) of a color circle to the printer 300. The image processing apparatus 1 generates and outputs image data (vector data, etc.) of a rectangular line to the cutting plotter 400.

The image processing apparatus 1 can include, for example, a general-purpose electronic device (computer).

The electronic device can be, for example, a personal computer, a mobile terminal such as a smartphone, a tablet terminal, or the like.

As illustrated in FIG. 1, the image processing apparatus 1 includes a control unit 11 and a storage unit 12. An operation unit 13 and a display unit 14 are connected to the image processing apparatus 1. The operation unit 13 can include, for example, an input device such as a keyboard, a mouse, a touch pad, a touch panel, or a physical switch. The display unit 14 can include a display device such as a liquid crystal display or an organic electroluminescent (EL) display. The operation unit 13 and the display unit 14 may be provided integrally with the electronic device, or may be connected to the electronic device in a wired or wireless manner.

In the storage unit 12, an application program for implementing the function of the control unit 11 of the image processing apparatus 1 is installed. When a user activates the application program via the operation unit 13, the function of the control unit 11 is implemented in the electronic device.

The control unit 11 causes the display unit 14 to display various screens for generating image data.

The control unit 11 performs an image data generation process in accordance with the user's operation input performed via the screen.

In the storage unit 12, data necessary for the process by the control unit 11 is stored, and the result of the process of the control unit 11 is temporarily stored. As an example, the storage unit 12 stores data files DFa, DFb, DFc for a design, a design placement form, and a form, which are used to generate image data.

The control unit 11 outputs image data using the design or the design placement form to the image forming apparatus 200.

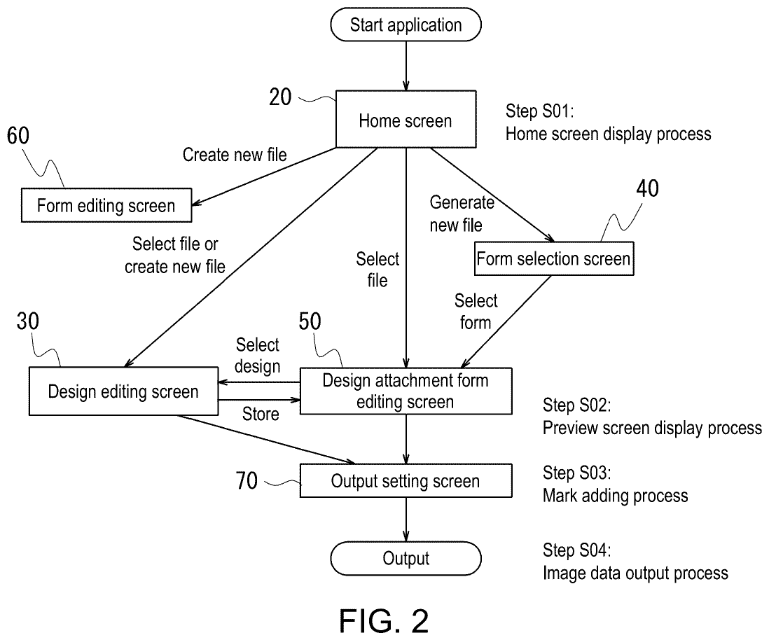

FIG. 2 is a diagram illustrating a screen that the control unit 11 causes the display unit 14 to display along a flow until image data is output.

As illustrated in FIG. 2, the control unit 11 causes the display unit 14 to display a home screen 20, a design editing screen 30, a form selection screen 40, a design placement form editing screen 50, a form editing screen 60, an output setting screen 70, and the like.

When the user starts the application program, the control unit 11 causes the home screen 20 to be displayed (step S01: home screen display process). The control unit 11 performs a process of displaying another screen from the home screen 20 in accordance with the user's operation performed via the home screen 20.

For example, the control unit 11 causes the display unit 14 to display the design editing screen 30, the design placement form editing screen 50, and the output setting screen 70, which are preview screens of the image data (step S02: preview screen display process).

For example, when the user newly generates or edits image data, the control unit 11 causes the design editing screen 30 or the design placement form editing screen 50 to be displayed. The control unit 11 also causes the output setting screen 70 to be displayed when the user performs output settings for image data to the image forming apparatus 200.

The control unit 11 performs a process of adding a crop mark to the image data as one of the output settings performed on the output setting screen 70 (step S03: mark adding process).

The control unit 11 also performs a process of outputting image data to the image forming apparatus 200 in accordance with the user's operation performed on the output setting screen 70 or the like (step S04: image data output process).

Hereinafter, each screen displayed by the control unit 11 and a process performed by the control unit 11 on each screen will be described.

### Home Screen

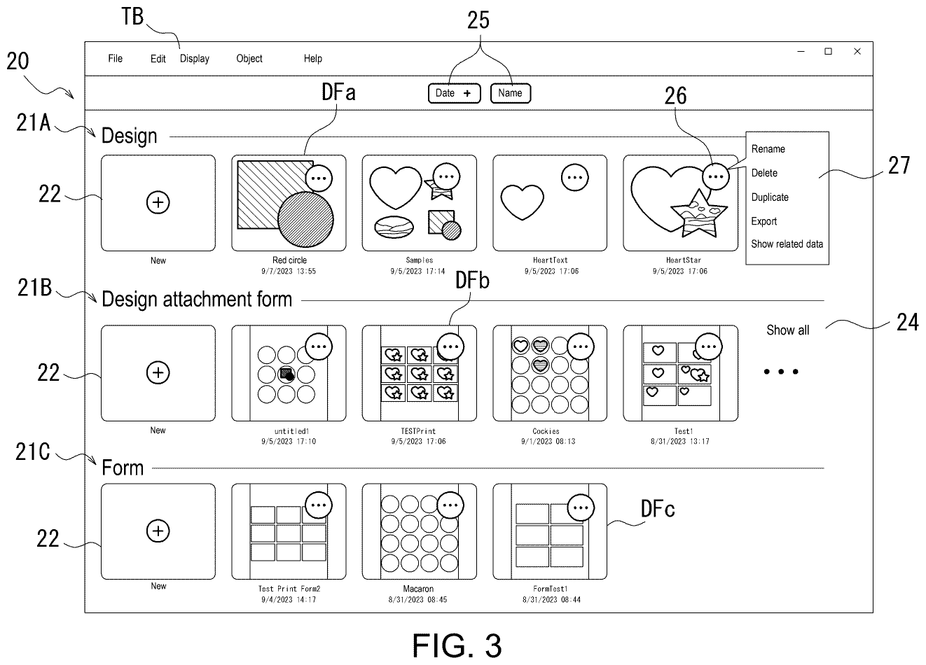

FIG. 3 is a view illustrating an example of the home screen 20.

As illustrated in FIG. 3, the home screen 20 includes a design display field 21A, a design placement form display field 21B, and a form display field 21C.

The design can be used for image data and is formed in a combination of one or more objects.

The form is a template with which a design can be combined.

The design placement form is a combination of the design and the form and is generated by placing the design on the form.

As described above, the storage unit 12 (cf. FIG. 1) stores the data files DFa, DFb, DFc for these three items. When the application program is activated, the control unit 11 reads pieces of information on the data files DFa, DFb, DFc from the storage unit 12 and causes the read pieces of information to be displayed in the corresponding display fields 21A, 21B, 21C.

As illustrated in FIG. 3, the display fields 21A, 21B, 21C are displayed side by side in the vertical direction of the home screen 20 (first direction, top-bottom direction in the figure).

The design placement form display field 21B is displayed between the design display field 21A and the form display field 21C in the vertical direction.

In this manner, the display fields 21A, 21B, 21C for displaying the data files DFa, DFb, DFc for the three items are displayed side by side on the home screen 20, making it possible to save the user from having to browse the display screen for each of the data files DFa, DFb, DFc. Further, by viewing the display fields 21A, 21B, 21C, the user can easily understand what options are available at the time of generating image data.

Then, the display of the design placement form display field 21B between the design display field 21A and the form display field 21C makes it easy to visualize how the design is combined with the form.

The display fields 21A, 21B, 21C are provided along the horizontal direction of the home screen 20 (second direction). New generation buttons 22 for respectively generating new data files DFa, DFb, DFc are provided at left ends of the display fields 21A, 21B, 21C.

On the right sides of the new generation buttons 22 in the display fields 21A, 21B, 21C, pieces of information on the data files DFa, DFb, DFc stored in the storage unit 12 are displayed side by side in the horizontal direction.

As information on each of the data files DFa, DFb, DFc, the display fields 21A, 21B, 21C can display, for example, at least one of a thumbnail, a file name, or last update time information.

The display fields 21A, 21B, 21C display a call mark 26 for a pop-up menu 27 in each of the display areas for the data files DFa, DFb, DFc.

In the display fields 21A, 21B, 21C, there are upper limits on the number of displayable data files DFa, DFb, DFc in accordance with the size of the screen. When the number of data files DFa, DFb, DFc stored in the storage unit 12 exceeds the displayable number of display fields 21A, 21B, 21C, an item screen calling unit 24 is displayed at the right end of each of the display fields 21A, 21B, 21C. For example, a text such as “Show all” can be displayed in the calling unit 24.

On the upper side of the display fields 21A, 21B, 21C on the home screen 20, a sorting unit 25 for extracting and sorting the data files DFa, DFb, DFc displayed in the display fields 21A, 21B, 21C is displayed.

A task bar TB is displayed above the sorting unit 25 on the home screen 20. Processes executable by the control unit 11 are displayed on the task bar TB. By the user selecting a process with the mouse or the like, the control unit 11 executes the selected process.

The user can perform various operation inputs via the home screen 20.

Hereinafter, an example of processes performed by the control unit 11 in accordance with the user's operation input performed via the home screen 20 will be described.

### Display of Editing Screen

When the user selects the new generation button 22 or the data file DFa, DFb, or DFc displayed in the display field 21A, 21B, or 21C on the home screen 20, the control unit 11 causes the display unit 14 to display the editing screen corresponding to the selected item. The editing screen is the design editing screen 30, the design placement form editing screen 50, or the form editing screen 60 illustrated in FIG. 1. Details of each editing screen will be described later.

For example, the user can select the new generation button 22 or the data file DFa, DFb, or DFc by clicking or double-clicking with the mouse. When the operation unit 13 is a touch panel, the user can make a selection by tapping or long-pressing the data file DFa, DFb, or DFc with a finger or a touch pen, for example.

### Highlighting

The control unit 11 causes the target selected on the home screen 20 by the user to be highlighted on the home screen 20. “Highlighting” means that the selected target is displayed in a manner different from the others. A highlighting target may be, for example, the entire display fields 21A, 21B, 21C or each of the individual data files DFa, DFb, DFc displayed in the display fields 21A, 21B, 21C.

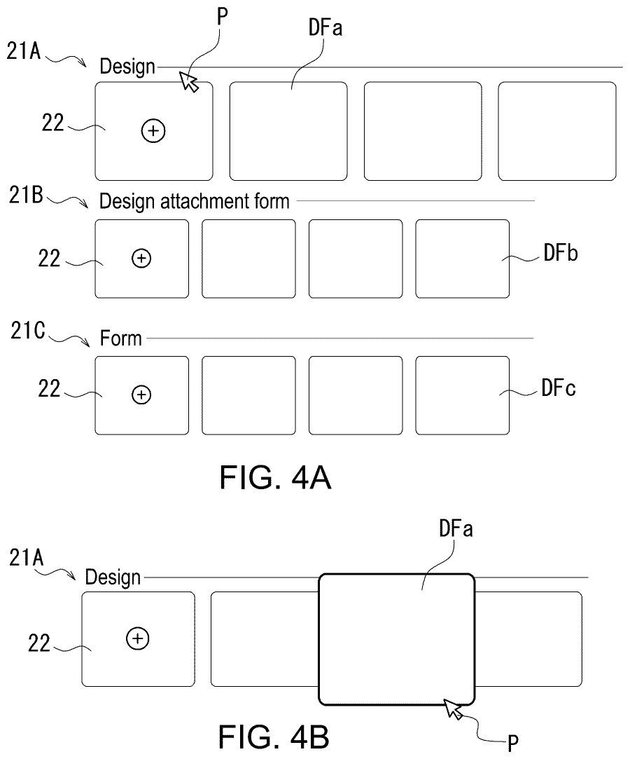

FIG. 4A and FIG. 4B are views for explaining highlighting.

FIG. 4A illustrates an example of highlighting the entire display field. In FIG. 4A, the display field 21A is highlighted.

For example, when a pointer P of the mouse or the like operated by the user overlaps the display field 21A, the control unit 11 can cause the display field 21A to be highlighted. For example, as the highlighting, the control unit 11 can cause the selected display field 21A to be displayed larger than the other display fields 21B, 21C. Alternatively, as the highlighting, the control unit 11 can cause the selected display field 21A to be imparted with a floating effect, to have a changed background color, or to be subjected to other forms of display.

Since the display field 21A selected by the user is highlighted, the user can easily confirm the information on the data file DFa displayed in the display field 21A. This also enables the user to confirm the display fields 21B, 21C together, so that the user can easily consider which form the design is to be combined into and specifically visualize the final product.

FIG. 4B is a view illustrating an example of highlighting the data file DFa. FIG. 4B illustrates an example of highlighting the data file DFa in the display field 21A.

For example, when the pointer P of the mouse or the like operated by the user overlaps one of the data files DFa in the display field 21A, the control unit 11 can highlight that data file DFa. For example, as the highlighting, the control unit 11 can cause the selected data file DFa to be displayed larger than other data files DFa. Alternatively, the control unit 11 can cause the selected data file DFa to be imparted with a floating effect, to have a changed background color, to be surrounded with a frame, or to be subjected to other forms of display.

Since the data file DFa is highlighted, the user can easily confirm information on the data file DFa. For example, by displaying the thumbnail of the data file DFa in a larger size, the user can easily confirm details of the design.

Note that the control unit 11 can perform a combination of highlighting of the entire display fields 21A, 21B, 21C and highlighting of the individual data files DFa, DFb, DFc. For example, when the user selects the individual data file DFa, DFb, or DFc from the display field 21A, 21B, or 21C, which has been highlighted in accordance with the user's selection, the control unit 11 can further highlight that data file DFa, DFb, or DFc.

### Pickup Display

When the user selects one of the data file DFa, DFb, or DFc for the design, the design placement form, or the form on the home screen 20 (cf. FIG. 3), the control unit 11 searches for data files DFa, DFb, DFc for the other related items and displays the data files in a pickup display.

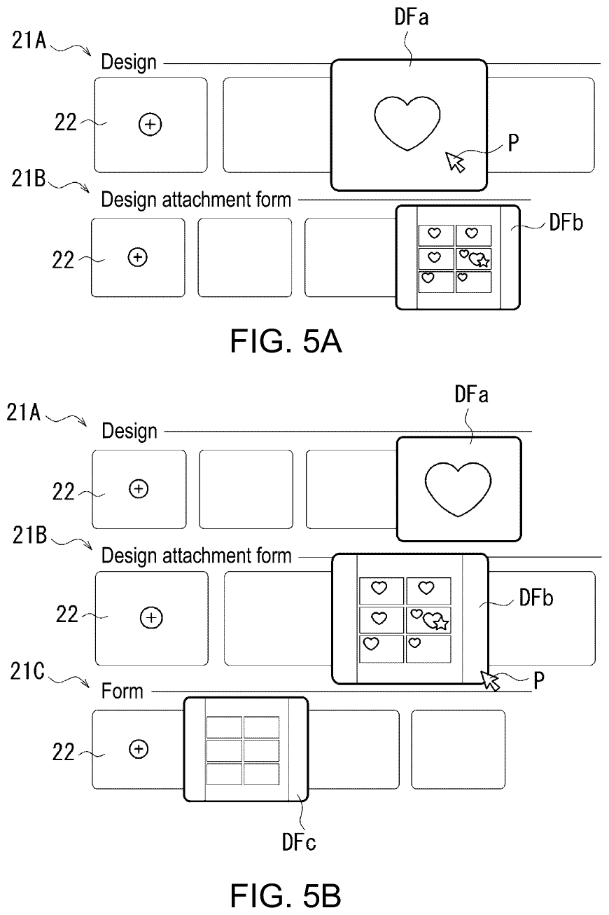

FIG. 5A and FIG. 5B are views for explaining a pickup display.

FIG. 5A illustrates a pickup display when the data file DFa for the design is selected. FIG. 5B illustrates an example of the pickup display when the data file DFb for the design placement form is selected.

As illustrated in FIG. 5A, when the user selects one of the data files DFa for the design displayed in the display field 21A, the control unit 11 causes the data file DFb for the design placement form using the selected design to be displayed in a pickup display in the display field 21C.

As illustrated in FIG. 5B, when the user selects one of the data files DFb for the design placement form displayed in the display field 21B, the control unit 11 causes the data file DFa for the design used for the selected design placement form to be displayed in a pickup display in the display field 21A. Moreover, the control unit 11 causes the data file DFc for the form used for the selected design placement form to be displayed in a pickup display in the display field 21C.

Although not illustrated, when the user selects one of the data files DFc for the form displayed in the display field 21C, the control unit 11 can cause the data file DFb for the design placement form using the selected form to be displayed in a pickup display in the display field 21B.

“Selecting data files DFa, DFb, DFc” is not limited to a specific operation. For example, the user can select the data files DFa, DFb, DFc by placing the pointer P of the pointing device (mouse, touch pad, touch panel, etc.) on the data files DFa, DFb, DFc.

The mode of “displaying in a pickup display” is not limited to a specific mode, but means displaying in a mode in which the relationship between the data file DFa, DFb, or DFc selected by the user and the data files related to the selected file is clear.

For example, the control unit 11 can cause only data files related to the selected data file DFa, DFb, or DFc to be displayed in the display fields 21A, 21B, 21C. Alternatively, the control unit 11 may cause each of the related data files to have a larger thumbnail than other data files, to be imparted with a floating effect, to be surrounded with a frame, to have a changed background color, or to be subjected to another form of display.

With only the thumbnail displayed on the home screen 20, it may be difficult to discern what design has been used for the design placement form, for example. In particular, when the design placement form uses a large number of designs or when a plurality of persons is editing the same design placement form, it may be difficult to access the data file Dfa for the original design.

In the present embodiment, since the data files related to the data file DFa, DFb, or DFc selected by the user are displayed in a pickup display on the home screen 20, the user can easily access the related data files.

### Extraction, Sorting

The control unit 11 extracts or sorts the data files DFa, DFb, DFc displayed in the display fields 21A, 21B, 21C in accordance with a condition specified by the user.

As illustrated in FIG. 3, the user can specify a condition for extraction or sorting by operating the sorting unit 25 displayed on the home screen 20.

Examples of conditions for extraction or sorting include the types of the data files DFa, DFb, DFc, the date of last update, the data size, and the file name.

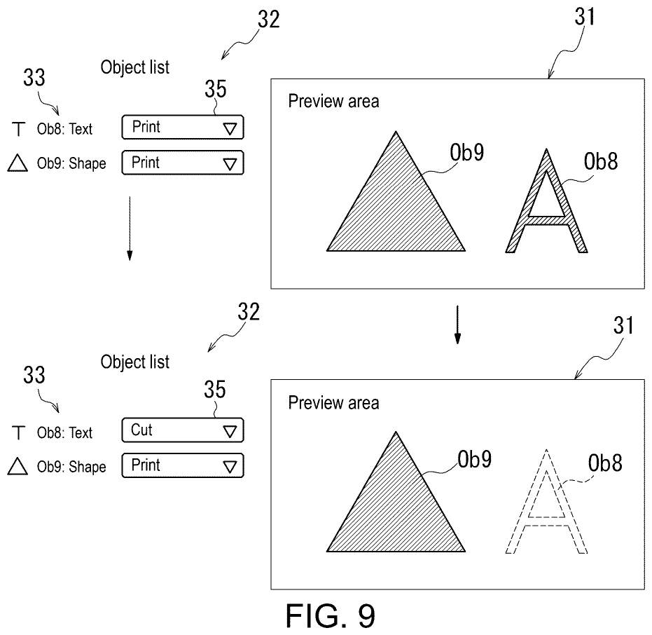

Although details will be described later, the design may include an object Ob (cf. FIG. 9) for which “Cut” is designated as processing content. For example, the control unit 11 can extract, from the data files DFa, DFb for the design or the design placement form, only the data files DFa, DFb including the object Ob for which “Cut” is designated.

For example, the object Ob for which “Print” is designated and the object Ob for which “Cut” is designated may be mixed in the data file Dfa for one design. However, it is difficult to discern the object Ob for which cutting is designated from the thumbnail displayed on the home screen 20. By an extraction process, the user can easily access the data file DFa including the object Ob for which cutting is designated.

### Display of Pop-up Menu

As illustrated in FIG. 3, the calling mark 26 for the pop-up menu 27 is displayed in each of the display areas for the data files DFa, DFb, DFc of the display fields 21A, 21B, 21C. For example, the user can perform an operation such as clicking of the mouse on the calling mark 26.

The control unit 11 displays the pop-up menu 27 in accordance with the operation of the calling mark 26 by the user. The pop-up menu 27 describes processes that can be executed on each of the data files DFa, DFb, DFc. When the user selects a desired process from the displayed pop-up menu 27 by clicking or the like, the control unit 11 performs the selected process.

In the example of FIG. 3, the pop-up menu 27 shows “Rename”, “Delete”, “Duplicate”, “Export”, and “Show related data”.

When “Rename” is selected, the control unit 11 displays the file name input field and changes the file name of the data file DFa, DFb, or DFc based on the input content. When “Delete” is selected, the control unit 11 deletes the data file DFa, DFb, or DFc from the storage unit 12.

When “Duplicate” is selected, the control unit 11 duplicates and stores the selected data file DFa, DFb, or DFc in the storage unit 12, and causes the display unit 14 to display the editing screen corresponding to the duplicated data file DFa, DFb, or DFc. When duplicating the data file DFa, DFb, or DFc, the control unit 11 adds “-copy” or the like to the end of the file name so that the data file can be distinguished from the original data file DFa, DFb, or DFc.

When “Export” is selected, the control unit 11 exports the data file DFa, DFb, or DFc to a storage medium specified by the user.

When “Show related data” is selected, the control unit 11 performs the pickup display described above. That is, data files related to the data file DFa, DFb, or DFc are searched for, and the corresponding data files are displayed in a pickup display in the corresponding display fields of the display fields 21A, 21B, 21C.

Note that the processes displayed in the pop-up menu 27 are not limited to the processes described above, and can be appropriately set.

### Display of Item Screen

When the user clicks the item screen calling unit 24 displayed on the home screen 20 with the mouse, for example, the control unit 11 causes the display unit 14 to display an item screen (not illustrated) that displays only the data file for the corresponding item.

In the example of FIG. 3, when the user clicks the item screen display button of the display field 21B, the control unit 11 reads information on all the data files DFb for the design placement forms from the storage unit 12 and causes the item screen for the design placement form to be displayed.

When the number of data files DFa, DFb, DFc stored in the storage unit 12 is large for the respective items of the design placement form, and the form, all the data files DFa, DFb, DFc may not be displayed in the display fields 21A, 21B, 21C. In this case, the user can click the calling unit 24 on the home screen 20 to view the item screen that displays only the data file for the corresponding item. Accordingly, even when the number of data files DFa, DFb, DFc is large, the user can easily access a desired data file. When the user selects one of the data files DFa, DFb, or DFc displayed on the item screen, the control unit 11 causes the editing screen for the corresponding item to be displayed.

### Design Editing Screen

As illustrated in FIG. 2, for example, when the user selects the new generation button 22 or one of the data files DFa displayed in the design display field 21A on the home screen 20 (cf. FIG. 3), the control unit 11 causes the display unit 14 to display the design editing screen 30 (preview screen).

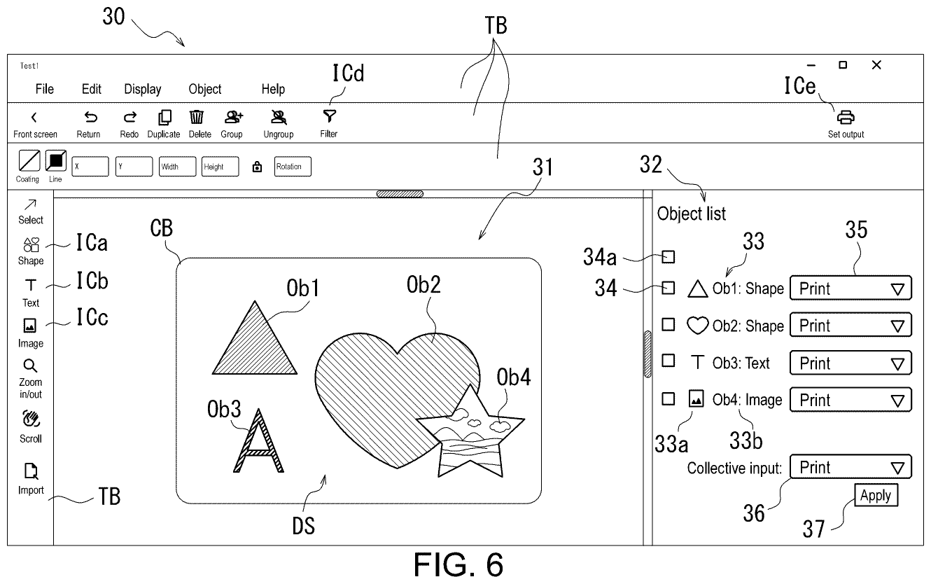

FIG. 6 is a view illustrating an example of the design editing screen 30.

As illustrated in FIG. 6, the design screen includes a preview area 31 and an object list 32.

In the example of FIG. 6, the preview area 31 is disposed at the center of the design editing screen 30, and the object list 32 is disposed adjacent to the preview area 31.

A task bar TB is also disposed on the design editing screen 30. A menu indicating operation content and an icon selectable by the user, a numerical value input field, and the like are displayed on the task bar TB. The user can select a desired menu or icon with the mouse or the like and input a necessary setting value with the keyboard or the like.

The control unit 11 also performs a process in accordance with the user's operation performed via the task bar TB, and reflects the result of the process in the preview area 31 and the object list 32.

The preview area 31 displays a preview of a design DS.

A canvas CB is displayed in the preview area 31, and objects Ob1 to Ob4 constituting the design DS are arranged on the canvas CB. When the objects Ob1 to Ob4 are referred to without distinction, the objects are denoted as an “object Ob”.

For example, the user can select a graphic shape icon ICa on the task bar TB to generate graphic shape objects Ob1, Ob2 on the canvas CB. The graphic shape includes a circle, a polygon, a graphic shape obtained by a combination of curved and straight lines, a graphic shape drawn free hand, and the like. The user can set a color to be applied to the graphic shape and the line type of the graphic shape.

FIG. 6 illustrates an example in which objects Ob1, Ob2 of triangular and heart-shaped graphic shapes are generated. In FIG. 6, colors are indicated by hatching.

The user can, for example, select a text icon ICb on the task bar TB to generate a text object Ob3 on the canvas CB. The user can set the color, line type, and font type of the text. The example of FIG. 6 shows an example in which an object Ob3 of text “A” is generated.

The user can, for example, select an image icon ICc on the task bar TB and load the image onto the canvas CB to generate an image object Ob4. The image includes, for example, a photograph, an illustration, and the like. It is also possible to display the image in a predetermined shape by loading the image into the form.

In the example of FIG. 6, an object Ob4 of an image, generated by loading a picture into a star-shaped form, is illustrated.

The object list 32 displays object information 33 in a list format.

When generating the object Ob in accordance with the user's operation input, the control unit 11 displays information 33 on the generated object in the object list 32.

In the object list 32, for example, an attribute (graphic shape, text, image, etc.) of each object Ob is indicated by an icon 33a and characters 33b as information on the object. The icon 33a can indicate, for example, the attribute of the object Ob. For example, in the case of the graphic shape object Ob, the icon 33a can correspond to a graphic shape such as a triangle or a heart-shaped figure. The icon 33a enables the user to easily understand the correspondence between the object Ob displayed in the preview area 31 and the object information 33 listed in the object list 32.

The object information 33 is not limited to the illustrated example. For example, when a plurality of objects Ob are displayed in an overlapping manner in the preview area 31, the overlapping order of the objects Ob can be displayed as the object information 33.

The object list 32 is provided with a check box 34 and a processing input unit 35 in addition to the object information 33. The processing input unit 35 is a field for inputting processing content for the object Ob.

The user can input a check mark into the check box 34 by clicking with the mouse or the like. The check box 34 is used when the user selects a specific object Ob from the object list 32.

A collective input check box 34a is provided above the object list 32. When the user inputs a check mark into the check box 34a, the control unit 11 collectively inputs check marks into all the check boxes 34.

At the lower part of the object list 32, a collective input unit 36 is provided to enable collective input of processing content for the object Ob for which a check mark has been input.

When a plurality of objects Ob having similar shapes and colors are displayed in the preview area 31, it may be difficult to understand the correspondence between the preview area 31 and the object list 32.

Therefore, when the user selects the object Ob displayed in one of the preview area 31 or the object list 32, the control unit 11 can change the display of the same object Ob displayed in the other.

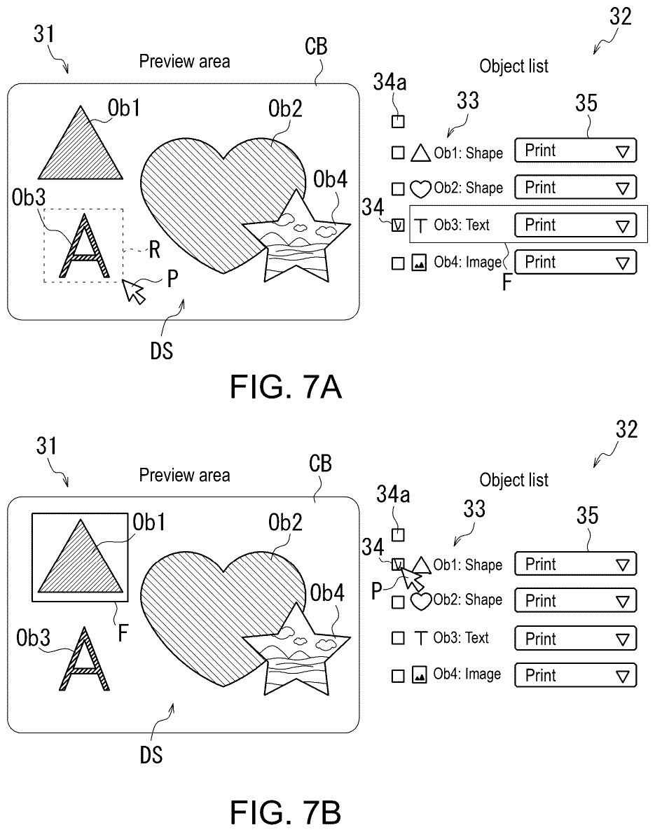

FIG. 7A is a view for explaining a change in the display of the object list 32 when the object Ob in the preview area 31 is selected, and FIG. 7B is a view for explaining a change in the display of the preview area 31 when the object Ob in the object list 32 is selected.

As illustrated in FIG. 7A, for example, the user can select the object Ob3 by placing the pointer P of the mouse on the object Ob3 displayed in the preview area 31 and clicking, or by dragging the range R that includes at least a part of the object Ob3.

For example, the control unit 11 displays the object Ob3 selected in the preview area 31 in a mode different from the other objects Ob1, Ob2, Ob4 in the object list 32. For example, as illustrated in FIG. 7A, the control unit 11 displays the selected object Ob3 by surrounding the selected object Ob3 with a frame line F. The control unit 11 may input a check mark into the check box 34 of the selected object Ob3. Alternatively, the control unit 11 can change the display color of the selected object Ob3, add an underline, change the display size, or perform other processes.

As illustrated in FIG. 7B, for example, the user can select the object Ob1 by placing the pointer P of the mouse on the check box 34 of the object Ob1 in the object list 32 and clicking to input a check mark.

The control unit 11 displays the selected object Ob1 in a mode different from the other objects Ob2 to Ob4 in the preview area 31. For example, as illustrated in FIG. 7B, the control unit 11 displays the selected object Ob1 by surrounding the selected object Ob1 with a frame line F. Alternatively, the control unit 11 can cause the selected object Ob1 to be displayed in a blinking manner, change the display color, or perform other processes.

In this manner, when the user selects the object Ob displayed in one of the preview area 31 or the object list 32, the control unit 11 changes the display of the same object Ob displayed in the other. This enables the user to easily understand the correspondence between the preview area 31 and the object Ob in the object list 32. Even when the design DS includes many objects Ob or the objects Ob overlap each other, it is possible to smoothly understand the attribute of each object Ob and the processing content setting.

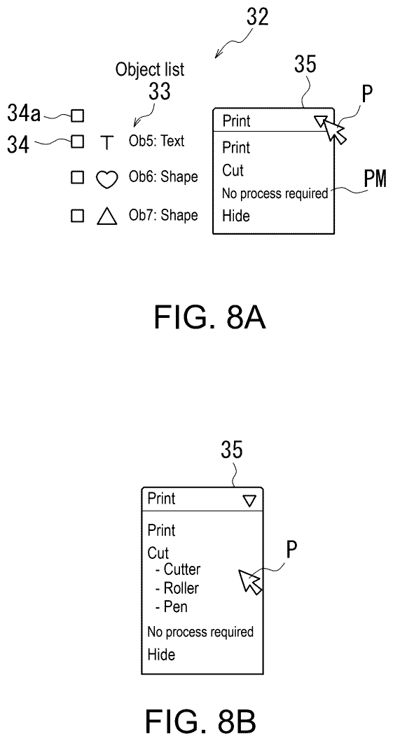

FIG. 8A is a view for explaining the processing input unit 35. FIG. 8B is a view illustrating a variation of the processing input unit 35.

As illustrated in FIG. 8A, the processing input unit 35 can select processing content to be performed on the object Ob from, for example, a pull-down menu PM. When the user places the pointer P of the mouse on the processing input unit 35 and clicks the processing input unit 35, the control unit 11 displays a pull-down menu PM describing selectable processing content.

In the pull-down menu PM, processing content to be performed by the image forming apparatus 200 (cf. FIG. 1) and processing content to be performed by the control unit 11 can be described. In the example of FIG. 8A, the pull-down menu PM displays “Print”, “Cut”, “No process required”, “Hide”, and the like.

“Print” means printing with the printer 300, and “Cut” means cutting with the cutting plotter 400 or the like.

“No process required” means that no process is performed in the image forming apparatus 200. That is, the object Ob for which “No process required” is selected is excluded from the image data that is output to the image forming apparatus 200.

Similarly to “No process required”, “Hide” means that no process is performed in the image forming apparatus 200 and the object Ob is not displayed in the preview area 31.

As described above, various cutting members 403 (cf. FIG. 1), such as a cutter, a roller, and a pen, can be used in the cutting plotter 400. Therefore, as illustrated in FIG. 8B, the pull-down menu PM can also enable selection of the cutting member 403 (cutter, roller, pen, etc.) for use in cutting.

FIG. 9 is a view illustrating a display mode of the object Ob in accordance with processing content set by the processing input unit 35.

As illustrated in FIG. 9, for example, “Print” can be input as default processing content to the processing input unit 35.

When the user changes the processing content from “Print” to another processing content, the control unit 11 can change the display mode of the object for which the processing content has been changed in the preview area 31.

FIG. 9 illustrates a text object Ob8 and a graphic shape object Ob9. As illustrated in FIG. 9, when processing content is input as “Print”, the objects Ob8, Ob9 are displayed with solid lines and colored in the preview area 31.

When the user changes the processing content for the text object Ob8 from “Print” to “Cut”, the control unit 11 changes the text object Ob8 to be uncolored and displays its outline with cut lines in the preview area 31.

The “cut line” is not limited to a specific mode, but may differ in line type, line thickness, line color, and the like from the line that displays the object for which “Print” has been input. For example, as in the example of FIG. 7A and FIG. 7B, the cut line may be a broken line. Alternatively, the cut line may be a dotted line, a chain line, a thin solid line, or the like.

Similarly, the control unit 11 can change the display mode of the object Ob in the preview area 31 even when “No process required” or “Hide” (cf. FIG. 8A and FIG. 8B) is input by the processing input unit 35. For example, the control unit 11 can set the object Ob for which “No process required” has been input to be uncolored and display its outline as a light color line. For example, in the preview area 31, the control unit 11 can hide the object Ob for which “Hide” has been input.

If the object Ob that is not subjected to a process such as printing or cutting remains in the preview area 31, it may be difficult for the user to visualize the final product. In such a case, by switching the object Ob to a hidden state, the user can perform editing work while visualizing the final product.

Even when the object Ob is hidden in the preview area 31, the object information 33 and the processing input unit 35 are listed in the object list 32. The user can switch the object Ob to the displayed state again as necessary.

As described above, the display mode of the preview area 31 is changed in accordance with processing content for each object Ob, so that the user can easily visualize the final product.

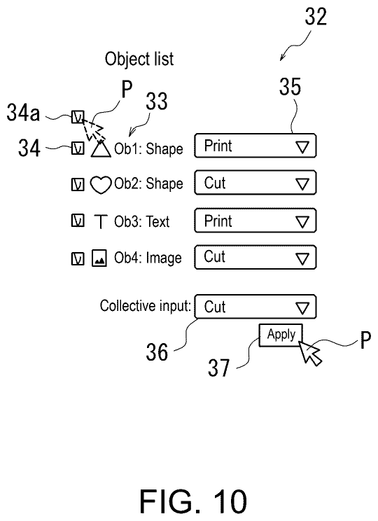

FIG. 10 is a view illustrating the collective input unit 36.

As described above, the user can input processing content for each object Ob using the processing input unit 35 provided for each object Ob. However, when the design DS includes a large number of objects Ob, the work of individually inputting processing content for each of the large number of objects Ob may become complicated.

In this case, the user can collectively set processing content for each of the plurality of objects Ob using the collective input unit 36 provided at the lower part of the object list 32.

The collective input unit 36 collectively sets processing content for each of the objects Ob for which a check mark has been input into the check box 34.

As described above, by inputting a check mark in the collective input check box 34a provided at the upper part of the object list 32, it is possible to input check marks into all the check boxes 34. Note that if there is an object Ob to be excluded from the collective input, the user can click the check box 34 to remove the check mark.

Alternatively, by clicking the object Ob displayed in the preview area 31 with the mouse or the like as described above, the user can input a check mark into the check box 34 (cf. FIG. 7A). Alternatively, by dragging the mouse to encompass a plurality of objects Ob, the user can collectively input check marks into the corresponding check boxes 34.

The user selects processing content to be applied in the collective input unit 36 and clicks an application button 37, so that the processing content can be collectively input for the plurality of objects Ob for each of which the check mark has been input into the check box 34.

As illustrated in FIG. 6, a filtering icon ICd is displayed on the task bar TB of the design editing screen 30. The control unit 11 performs filtering of the object Ob in accordance with the user's operation performed on the filtering icon ICd.

For example, when the user clicks the filtering icon ICd with the mouse or the like, the control unit 11 causes the display unit 14 to display an input field for inputting a filtering condition. The control unit 11 performs filtering in accordance with conditions input by the user.

The filtering condition can be, for example, the attribute of the object Ob, processing content, or the like. For example, as processing content, the user can input a condition to filter the object Ob for which “Cut” has been input.

The control unit 11 can perform the filtering process in accordance with the input condition and reflect the result of the filtering process in at least one of the object list 32 or the preview area 31.

For example, the control unit 11 can cause only the filtered object Ob to be displayed in the object list 32 and the preview area 31. For example, the control unit 11 can cause only the object Ob, for which “Cut” as the filtering condition has been input, to be displayed in the object list 32 and the preview area 31.

When a large number of objects Ob are included in the design DS and different processing content is input for each object Ob, performing the filtering process enables the user to easily understand whether appropriate processing content has been input for each object Ob.

Note that the process that can be performed via the design editing screen 30 is not limited to the example described here, and other processes can be appropriately executed.

When the user performs a design saving operation from the menu on the task bar TB, the control unit 11 stores, in the storage unit 12, the design DS generated on the design editing screen 30 and a data file DFa that records the processing content input into the processing input unit 35 (cf. FIG. 1).

### Form Selection Screen

As illustrated in FIG. 2, when the user clicks the new generation button 22 in the display field 21B (cf. FIG. 3) on the home screen 20, the control unit 11 causes the display unit 14 to display the form selection screen 40. Although not illustrated, the form selection screen 40 displays data files DFc for the form stored in the storage unit 12, for example, in a list format. When the user selects one of the data files DFc for the form displayed on the form selection screen 40, the control unit 11 transitions to the design placement form editing screen 50 for combining the selected form and design.

### Design Placement Form Editing Screen

As illustrated in FIG. 2, when the user selects one of the data files DFb for the design placement form displayed in the display field 21B (cf. FIG. 3) on the home screen 20, the control unit 11 directly transitions to the design placement form editing screen 50 (preview screen).

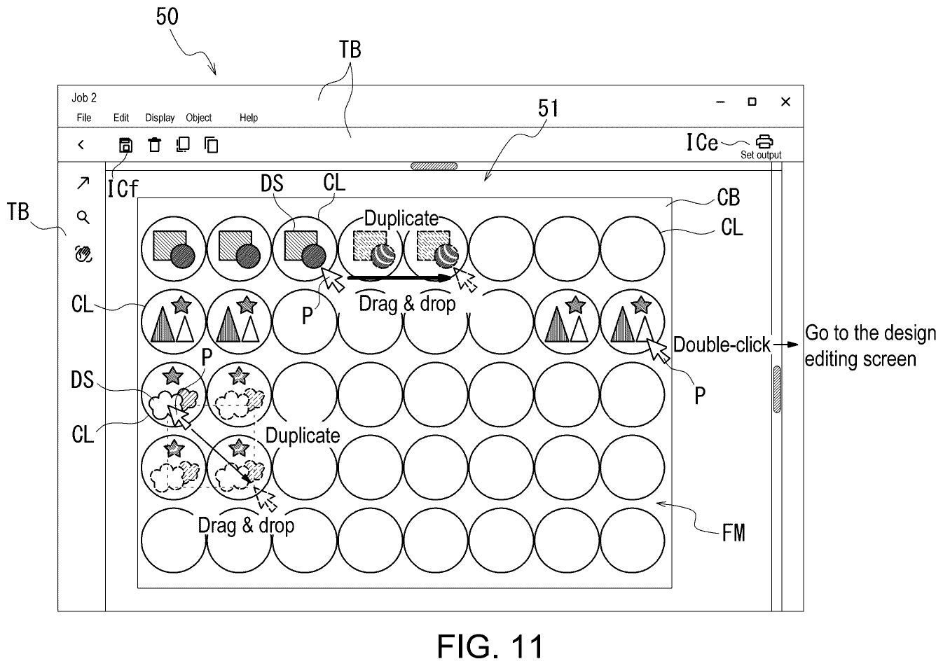

FIG. 11 is a view illustrating an example of the design placement form editing screen 50.

As illustrated in FIG. 11, the design placement form editing screen 50 includes a preview area 51 and a task bar TB.

A canvas CB is displayed in the preview area 51. A form FM selected by the user and the design DS combined with the form FM are arranged on the canvas CB. On the task bar TB, a menu, an icon, and the like indicating processing content executable by the control unit 11 are displayed. When the user selects the menu or the icon with the mouse or the like, the control unit 11 executes a process in accordance with the user's selection.

The control unit 11 also changes the display of the preview in the preview area 51 in accordance with the user's operation input.

The form FM includes one or more cells CL with which the design DS can be combined. The shape of the cell CL is not limited, and may be, for example, a circle, a polygon such as a rectangle, a graphic shape obtained by a combination of straight and curved lines, or the like.

For example, when the user generates a printed matter such as a seal, a sticker, or a card using the design DS, it is necessary to match the design DS to the shape (circle, quadrangle, etc.) of the printed matter. When printing is performed on the medium M such as a commercially available seal mount, it is necessary to generate the shape of the design DS to match the format of the mount and to set detailed duplication conditions such as offset, number of copies, and duplication spacing, which may complicate the work. By generating the form FM in accordance with medium M to be used in advance and combining the design DS with the form FM, the user can easily generate various printed matters.

In the example of FIG. 11, a form FM having a plurality of circular cells CL is illustrated.

As illustrated in FIG. 11, the design DS can be combined with each cell CL constituting the form FM. For example, the user selects the cell CL to be combined with the design DS by clicking or the like, and selects the data file DFa for the design DS to be loaded into the cell CL. The control unit 11 copies the selected data file DFa and combines the data file DFa with the cell CL. At the time of combination, the control unit 11 resizes the design DS to fit the size of the cell CL and crops the design DS in accordance with the shape of the cell CL.

The user can adjust the display range of the design DS in the cell CL by, for example, dragging the design DS in the cell CL with the mouse or the like, zooming out and zooming in with a wheel, or the like.

The user can set the necessity of printing for the contour line of the cell CL. For example, when the design placement form of FIG. 11 is printed on a sheet mount having a releasable circular-shaped seals, printing of the contour line of the cell CL is not necessary. In this case, the user can set the contour line of the cell CL without printing. The user can duplicate the design DS that has been loaded into one cell CL to another cell CL. For example, the user can duplicate the design DS by operating a duplication icon on the task bar TB. Alternatively, as illustrated in FIG. 11, the user can duplicate the design DS by clicking the design DS that has been loaded into the cell CL with the mouse or the like and dragging and dropping the design DS into another cell CL. At this time, when a plurality of cells CL enter the mouse drag range, the design DS can be duplicated to all the cells CL within the range.

In response to a request from the user, the control unit 11 is configured to display the design editing screen 30 (cf. FIG. 6) for editing the design DS that has been combined to obtain the design placement form. The user inputs the request by, for example, double-clicking the design DS combined with each cell CL with the mouse, or long-pressing the design DS with a finger in the case of a touch pad. The control unit 11 stores the design DS edited on the design editing screen 30 by the user in the storage unit 12 (cf. FIG. 1) as a new data file DFa. This enables the user to duplicate the edited design DS to another cell CL of the design placement form.

For example, when the user operates a save icon ICf on the task bar TB (cf. FIG. 11), the control unit 11 stores the generated data file Dfb for the design placement form in the storage unit 12 (cf. FIG. 1). As described above, the data file DFb for the design placement form is independent of the original data files DFa, DFc, since it is used by coping the form FM and the data files DFa, DFc for the design DS selected by the user.

The control unit 11 is configured to record information regarding the original form FM and the data files DFa, DFc for the design DS in the data file DFb for the design placement form. The information regarding each of the original data files DFa, DFc is configured to be, for example, the file name, the type of data file such as design DS or form FM, and the like.

The control unit 11 is configured to use the information regarding the original data files DFa, DFc, recorded in the data file DFb for the design placement form, for the pickup display (cf. FIG. 5A and FIG. 5B) on the home screen 20 (cf. FIG. 3).

For example, when the user selects one of the data files DFa for the design DS or one of the data files DFc for the form FM on the home screen 20, the control unit 11 can search for the data file DFb for the design placement form in which information regarding the selected data file Dfa for the design DS or the selected data file DFc for the form FM is recorded and cause the searched data file to be displayed in a pickup display.

When the user selects one of the data files DFb for the design placement form on the home screen 20, the control unit 11 can search for the data file DFa or DFc for the design DS or the form FM recorded in the selected data file Dfb for the design placement form and causes the searched data file to be displayed in a pickup display.

Note that the control unit 11 may embed hyperlinks to the original data files DFa, DFc for the design DS when combining the design DS with the cell CL (cf. FIG. 11). In this case, when the user double-clicks/long-presses the design DS combined with each cell CL, the control unit 11 can cause the design editing screen 30 for the original data file DFa to be displayed. The user may reflect the edited content in the original data file DFa, or may store the edited content in the storage unit 12 as another data file DFa.

### Form Editing Screen

The form FM with which the design is combined can be generated in advance as described above and stored in the storage unit 12 as a preset, but the user can also generate the form FM. The user can also edit the preset form FM.

For example, when the user selects the new generation button 22 or one of the data files DFc displayed in the form display field 21C on the home screen 20 (cf. FIG. 3), the control unit 11 causes the display unit 14 to display the form editing screen 60.

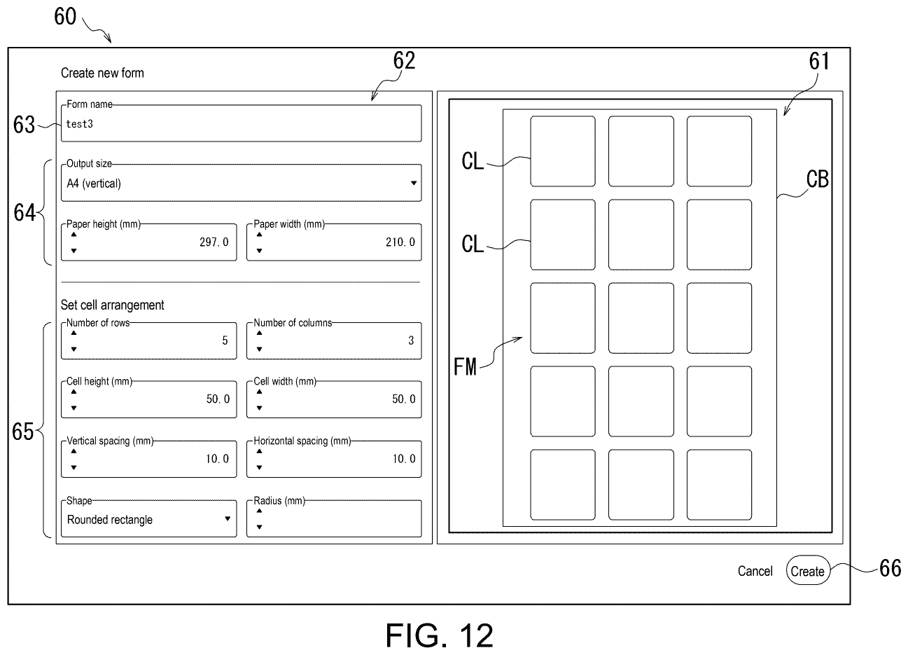

FIG. 12 is a view illustrating an example of the form editing screen 60.

As illustrated in FIG. 12, the form editing screen 60 includes a preview area 61 and a setting input unit 62.

In the preview area 61, the canvas CB is displayed, and the form FM generated by the user is displayed on the canvas CB.

Various settings for generating the form FM are allowed input of the setting input unit 62. The setting input unit 62 includes, for example, an input field 63 for a form name. The setting input unit 62 also includes an input field 64 for the medium M to which the form FM is applied. The input field 64 for the medium M includes, for example, an input field for setting values of output size, paper height, and paper width.

The setting input unit 62 also includes an input field 65 for the cell CL to be disposed in the form FM. The input field 65 for the cell CL includes, for example, input fields for the number of rows and columns of the cell CL, the height and width of each cell CL, the spacing between the cells CL in the vertical direction, the spacing in the horizontal direction, the shape of the cell CL, the radius of the cell CL (in the case of a circular-shaped cell CL), and the like.

The control unit 11 changes the display of the preview in the preview area 61 in accordance with the user's input into the setting input unit 62. When the user clicks a generation button 66 displayed on the form editing screen 60, the control unit 11 stores the generated data file DFc for the form FM in the storage unit 12 (cf. FIG. 1).

### Output Setting Screen

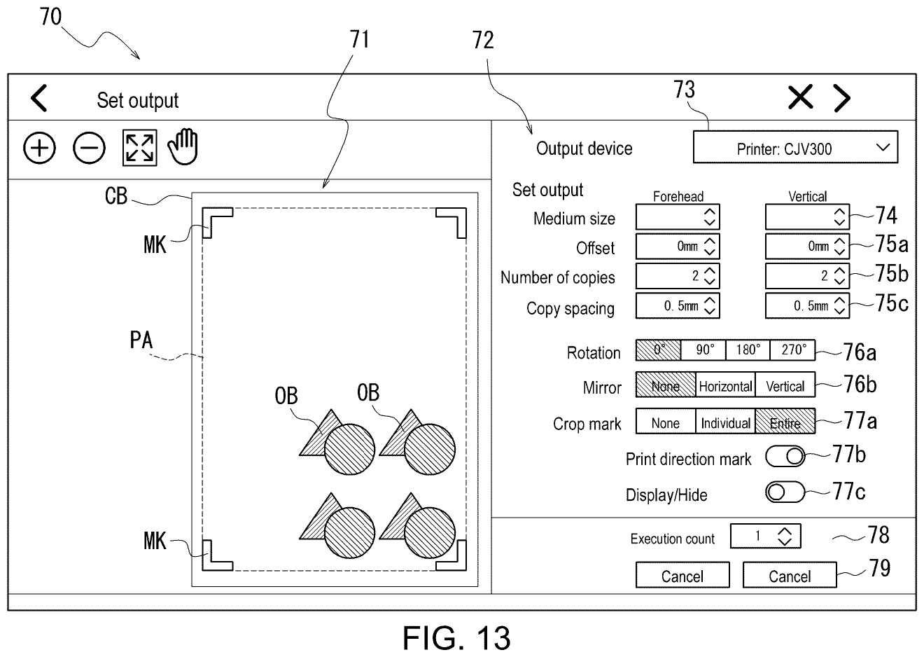

FIG. 13 is a view illustrating an example of the output setting screen 70.

The output setting screen 70 (preview screen) is a screen for inputting various settings for outputting a design or a design placement form generated by the user as image data in accordance with the specifications of the image forming apparatus 200.

When the user clicks an output setting icon ICe displayed on the design editing screen 30 (cf. FIG. 6) or the design placement form editing screen 50 (cf. FIG. 11), the control unit 11 causes the display unit 14 to display the output setting screen 70.

FIG. 13 illustrates, as an example, a case where a design is output as image data.

The output setting screen 70 includes a preview area 71 and a setting input unit 72 (mark setting input unit, duplication condition input unit).

As illustrated in FIG. 13, a canvas CB for arranging an object OB is displayed in the preview area 71. A printing area PA indicated by a broken line on the canvas CB represents an area in which the object OB can be disposed.

Note that the “object OB” on the output setting screen 70 means a set of a plurality of objects Ob (cf. FIG. 4A and FIG. 4B, etc.) constituting the design DS.

As illustrated in FIG. 13, an output setting for image data can be input into the setting input unit 72.

The control unit 11 reflects, in the display of the preview area 71, the setting content input by the user into the setting input unit 72.

The setting input unit 72 includes, for example, an input field 73 for the image forming apparatus 200 that outputs image data. In the input field 73, a model name and the like of a printer 300 or a cutting plotter 400 (cf. FIG. 1) is configured to be input as the image forming apparatus 200. The example of FIG. 11 shows an example in which the printer 300 is input into the input field 73.

Note that the cutting member 403 (cutter, roller, pen, etc.) to be used may also be selectable for the cutting plotter 400.

When the printer 300 is input into the input field 73, the object OB displayed in the preview area 71 is a set of objects Ob for which “Print” has been set as processing content on the design editing screen 30 (cf. FIG. 6).

When the cutting plotter 400 is input into the input field 73, the object OB displayed in the preview area 71 is a set of objects Ob for which “Cut” has been set as processing content on the design editing screen 30 (cf. FIG. 6).

The setting input unit 72 also includes an input field 74 for the size of the medium M. When the size of the medium M is set in advance as in the design placement form, the set numerical value is automatically input into the input field 74.

The setting input unit 72 includes input fields 75a, 75b, 75c. Input fields 75a, 75b, 75c for an offset, the number of copies (number of duplications), and a copy spacing (duplication spacing), which serve as duplication conditions for the object OB in the printing area PA, are included as the input fields 75a, 75b, 75c.

The offset means the distance of the object OB from the origin of the printing area PA.

The number of copies means the number of duplications of the object OB in the printing area PA.

The copy spacing means a spacing between the objects OB duplicated in the printing area PA.

In input fields C1, C2, C3, numerical values in the horizontal direction and the vertical direction of the printing area PA can be input for each of the offset, the number of copies, and the copy spacing.

As illustrated in FIG. 13, the control unit 11 causes an object OB, duplicated based on the input duplication condition (number of copies: vertical 2, horizontal 2), to be displayed in the preview area 71.

As described above, on the design placement form editing screen 50 (cf. FIG. 11), the design DS can be combined with the plurality of cells CL of the form FM to duplicate the design in various formats.

On the other hand, when the user simply wishes to duplicate and print the design DS without combining the design DS with the cell CL, the user can easily duplicate the design DS by inputting the duplication condition in the setting input unit 72 on the output setting screen 70.

As illustrated in FIG. 13, the setting input unit 72 also includes setting fields 76a, 76b for the rotation angle and inversion (mirror) of the object OB.

The illustrated example shows an example in which one of four angles of “0° (no rotation)”, “90°”, “180°”, or “270°” can be set as the rotation angle of the object OB in the setting field 76a. Note that the setting of the rotation angle is not limited to four stages, and can be changed as appropriate.

An example is also shown in which in the setting field 76b, the inversion mode of the object OB can be set to one of “None”, “Horizontal”, or “Vertical”. “Horizontal” means horizontal inversion, and “Vertical” means vertical inversion.

The setting input unit 72 also includes a setting field 77a for an addition setting for a crop mark MK.

The crop mark MK is an alignment mark printed on the medium M, and may be referred to as a crop mark, a trim mark, or a register mark.

For example, when the medium M is cut by the cutting plotter 400 after the medium M is printed by the printer 300 (cf. FIG. 1), a sensor provided in the cutting plotter 400 detects the crop mark MK printed on the medium M. The cutting plotter 400 can align cutting with the detected crop mark MK as a reference position. The cutting plotter 400 can also cut the medium M along the crop mark MK to form the printed matter into a finished size.

Even when the medium M is printed by one printer 300 and thereafter printed by another printer 300, the print position can be aligned by detecting the crop mark MK with a sensor provided in the printer 300.

In the example of FIG. 13, in the setting field 77a, the setting mode of the crop mark MK can be set to one of “None”, “Individual”, or “Entire”. Note that the addition setting for the crop mark MK is not limited thereto. For example, the setting input unit 72 may be provided with a field in which the size of the crop mark MK, the position for addition in the printing area PA, and the like can be set.

The control unit 11 performs a mark adding process (FIG. 2, Step S03) of adding the crop mark MK to the printing area PA in accordance with the setting input into the setting field 77a. The control unit 11 displays the added crop mark MK in the preview area 71. The setting input unit 72 is provided with a switch button 77c for displaying the crop mark MK. The control unit 11 switches between displaying and hiding the crop mark MK in the preview area 71 in accordance with the user's operation of the switch button 77c.

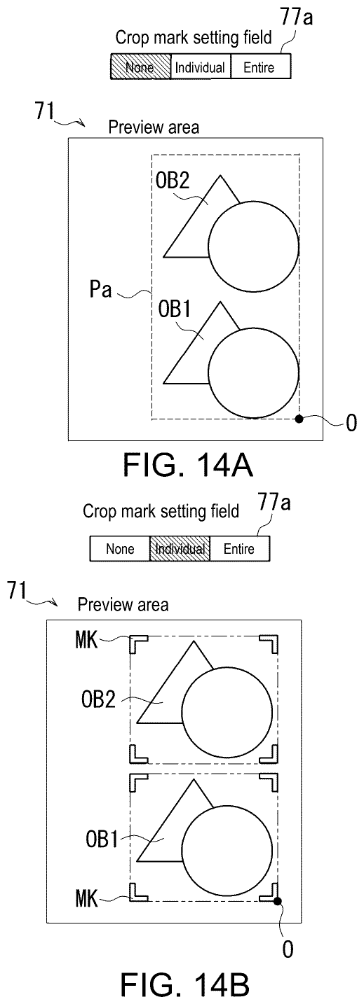

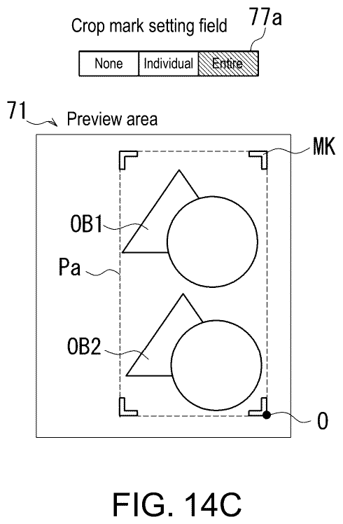

FIG. 14A to FIG. 14C are views illustrating a specific example of the mark adding process of the control unit 11.

FIG. 14A to FIG. 14C illustrate an example in which the number of copies of the object OB is set to “Horizontal: 1, Vertical: 2”. Further, hatching indicating the coloring of the object OB is omitted.

FIG. 14A illustrates a case where the crop mark MK is set to “None” in the setting field 77a. In this case, a duplication source object OB1 is disposed offset from an origin O of the printing area PA by the distance input into the input field 75a for the offset (cf. FIG. 13). A duplication destination object OB2 is disposed at a spacing input into the input field 75b for the copy spacing (cf. FIG. 11) from the duplication source object OB1.

As illustrated in FIG. 14B, when the user sets the addition setting for the crop mark MK to “Individual”, the control unit 11 adds the crop mark MK to each of the objects OB1, OB2 in the printing area PA.

As illustrated in FIG. 14C, when the user sets the addition setting for the crop mark MK to “Entire”, the control unit 11 adds the crop mark MK to the entire printing area PA.

The crop mark MK is not limited to a specific shape. As an example, the crop mark MK may have an L-shaped configuration in which a straight line extending in the horizontal direction is connected to one end of a straight line extending in the vertical direction, as illustrated in the figure. Alternatively, the crop mark MK may have a cross-shaped configuration in which a straight line extending in the vertical direction and a straight line extending in the horizontal direction intersect at the respective centers. Alternatively, the crop mark MK may be one of a straight line extending in the vertical direction or a straight line extending in the horizontal direction.

The mode of adding the crop mark MK is not limited to a specific mode.

For example, as illustrated in FIG. 14B, when the addition setting is set to “Individual”, the control unit 11 can set a rectangular area (e.g., an area indicated by a two-dot chain line in the figure) encompassing each object OB, and add the crop mark MK to each of the four corners of the area.

For example, as illustrated in FIG. 14C, when the addition setting is set to “Entire”, the control unit 11 can add the crop mark MK to each of the four corners of the printing area PA.

The control unit 11 adjusts the layout of the crop mark MK as necessary in the mark adding process. FIG. 14B and FIG. 14C each illustrate a state after the control unit 11 adjusts the layout of the crop mark MK.

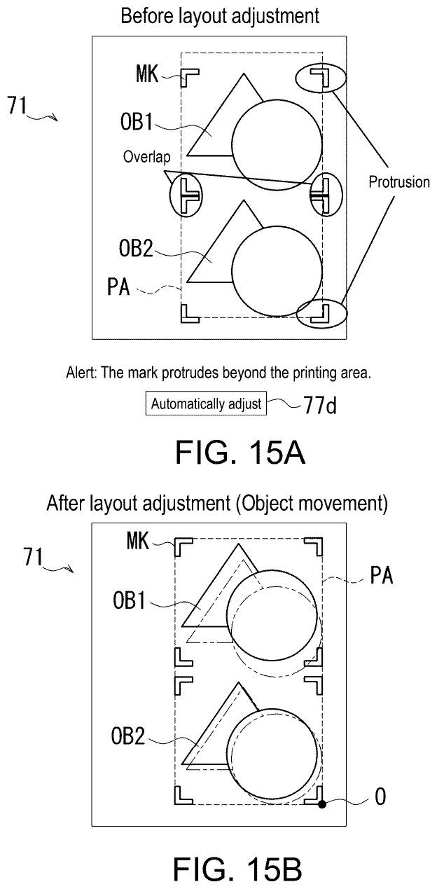

FIG. 15A and FIG. 15B are views illustrating an example of the layout adjustment of the control unit 11.

FIG. 15A is a view illustrating a state before the layout adjustment when the addition setting for the crop mark MK is set to “Individual”.

In FIG. 15A, the positions of the objects OB1, OB2 remain at the positions illustrated in FIG. 14A. When the crop mark MK is added to each of the objects OB1, OB2 in this state, crop marks MK protruding beyond the printing area PA or crop marks MK overlapping each other may occur. If printing is performed in this state, clipping or overlapping of crop marks MK may occur on the printed medium M, which may affect the accuracy of alignment in cutting.

When the crop mark MK is not appropriately added to the printing area PA, the control unit 11 can output an alert. FIG. 15A illustrates an example in which an alert message is displayed in the preview area 71, for example. The content of the message is not limited, and can be, for example, “Alert: The mark protrudes beyond the printing area”. The alert may alternatively be output in the form of a sound, a warning sound, a warning light, or the like.

The control unit 11 can cause an automatic adjustment button 77d to be displayed with the alert.

The automatic adjustment button 77d is a button for receiving an instruction to execute layout adjustment from the user. When the user clicks the automatic adjustment button 77d, the control unit 11 executes layout adjustment.

For example, the control unit 11 can adjust the layout of the crop mark MK based on at least one of the following pieces of information: the addition setting for the crop mark MK, the object information 33, the size of the crop mark MK, and the size of the medium M.

The “addition setting for the crop mark MK” is, for example, a setting of “Individual” or “Entire” that is input in the setting field 77a (cf. FIG. 13). The control unit 11 can perform layout adjustment in accordance with the addition setting.

The “object information” can be, for example, information such as the size of the object OB and duplication conditions (offset, number of copies, and copy spacing) for the object OB input into the input fields 75a, 75b, 75c (cf. FIG. 13). For example, when the crop mark MK cannot be appropriately added with the numerical values input into the input fields 75a, 75b, 75c, the control unit 11 can change the numerical values.

The “size of the crop mark MK” can be, for example, the size of the crop mark MK in the initial setting or the size of the crop mark MK specified by the user.

As illustrated in FIG. 15B, the control unit 11 is configured to adjust the position of the object OB as an example of the layout adjustment. Specifically, the control unit 11 increases or decreases the offset and the copy spacing of the object OB relative to the values input into the input fields 75a, 75b (cf. FIG. 13). As a result, the objects OB1, OB2 move from the original positions indicated by the two-dot chain lines to the positions indicated by the solid lines. As illustrated in FIG. 15B, the crop marks MK added to the moved objects OB1, OB2 do not protrude from the printing area PA, and the overlap between the crop marks MK has been eliminated. As a result, the crop mark MK can be appropriately printed on the medium M, and the accuracy of alignment in cutting can be maintained.

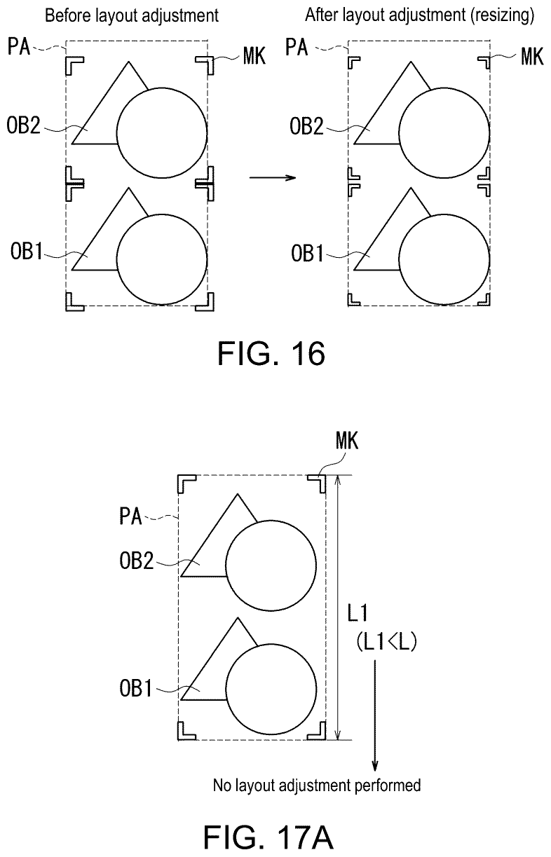

FIG. 16 is a view for explaining another example of the layout adjustment.

As illustrated in FIG. 16, the control unit 11 is configured to resize the crop mark MK when the crop mark MK protrudes beyond the printing area PA. In the illustrated example, the control unit 11 reduces the crop mark MK to eliminate protrusion from the printing area PA.

Note that the resizing is not limited to the illustrated example. For example, the control unit 11 may cut off only a portion of the crop mark MK protruding from the printing area PA. Alternatively, the control unit 11 may shorten the length of the crop mark MK in either the vertical direction or the horizontal direction.

Alternatively, the control unit 11 may resize the crop mark MK to a size instructed by the user. For example, the user can select the crop mark MK with the mouse and change the size by dragging or the like. When the user resizes one crop mark MK, the control unit 11 can resize the other crop marks MK together.

Note that the resizing of the crop mark MK may be performed in combination with layout adjustment by the movement of the object OB.

For example, when the protrusion of the crop mark MK from the printing area PA is not eliminated even if the crop mark MK is resized to the minimum size, the control unit 11 can perform a process such as moving the object OB or reducing the number of copies of the object.

In FIG. 14A to FIG. 16, an example has been described in which layout adjustment is performed when the crop mark MK protrudes beyond the printing area PA. However, layout adjustment is not limited to these examples.

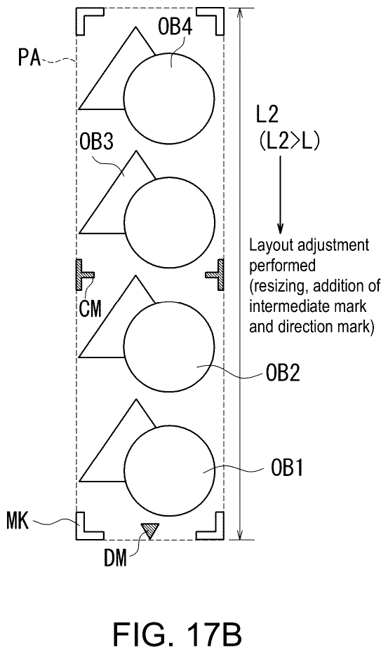

FIG. 17A and FIG. 17B are views for explaining layout adjustment in accordance with the length of the printing area PA. In the example of FIG. 17A and FIG. 17B, the crop mark MK is added to the entire printing area PA.

For example, when the length of the printing area PA exceeds a predetermined length L, the control unit 11 can perform layout adjustment of resizing the crop mark MK.

The “length of the printing area PA” corresponds to the length in the feed direction (cf. FIG. 1) in the printer 300 or the cutting plotter 400. Depending on the output settings for the image data, either the length in the vertical direction or the length in the horizontal direction in the printing area PA corresponds to the length in the feed direction. FIG. 15A and FIG. 15B illustrate an example in which the “length of the printing area PA” corresponds to the length in the vertical direction (top-bottom direction in the figure).

In the printer 300 or the cutting plotter 400, the longer the length of the medium M in the feed direction, the more likely misalignment is to occur. In order to reduce misalignment, there is a higher requirement for the accuracy of alignment using the crop mark MK. The larger the size of the crop mark MK, the easier it is to detect the crop mark MK using the sensor, and the easier it is to maintain the accuracy of alignment. On the other hand, when the size of the crop mark MK is increased, the layout of the object OB is restricted, and the amount of ink required to print the crop mark MK increases.

Therefore, the control unit 11 increases the size of the crop mark MK when the length of the printing area PA exceeds the predetermined length L, which is a guide that affects the accuracy of alignment. As a result, the crop mark MK can be resized in accordance with the accuracy required for alignment.

FIG. 17A illustrates an example in which a length L1 of the printing area PA is shorter than the predetermined length L.

In this case, the control unit 11 does not perform layout adjustment, and adds the crop mark MK having the initial setting size to each of the four corners of the printing area PA.

FIG. 17B illustrates an example in which a length L2 of the printing area PA is longer than the predetermined length L.

In this case, the control unit 11 is configured to add the crop mark MK, enlarged from the initial setting size, to each of the four corners of the printing area PA.

In addition to the enlarged crop mark MK, the control unit 11 is further configured to add an intermediate mark CM (intermediate alignment mark) and a direction mark DM to the printing area PA.

The intermediate mark CM can be added, for example, at an intermediate portion in the length direction of the printing area PA (top-bottom direction in the figure). The intermediate portion may be between one end and the other end in the length direction of the printing area PA, and is not limited to a strict center. The intermediate mark CM may be disposed at one position or a plurality of positions in the intermediate portion. In the illustrated example, the intermediate mark CM is disposed symmetrically at one end and the other end of the intermediate portion in the width direction (left-right direction in the figure).

The intermediate mark CM is not limited to a specific shape, and may have the same shape as or a different shape from the normal crop mark MK. In the illustrated example, the intermediate mark CM has a shape in which one end of a straight line extending in the horizontal direction is connected to the center of a straight line extending in the vertical direction.

In addition to the crop marks MK added to the four corners of the printing area PA, the intermediate marks CM are detected by the sensor and used for alignment, so that the accuracy of cutting can be easily maintained even when the printing area PA becomes longer.

The direction mark DM is a mark indicating the feed direction of the medium M in the printer 300 or the cutting plotter 400. The direction mark DM can be printed, for example, on one end side (lower side in the figure) in the length direction of the printing area PA corresponding to the upstream side in the feed direction.

The direction mark DM can be, for example, a mark such as a triangle with its vertex pointing downstream in the feed direction, an arrow indicating downstream in the feed direction, or the like.

When setting the medium M printed by the printer 300 on the cutting plotter 400, the user can easily understand the correct setting direction by referring to the direction mark DM.

The control unit 11 is configured to cause the intermediate mark CM and the direction mark DM to be displayed in a mode different from the normal crop mark MK in the preview area 71. For example, each of the intermediate mark CM and the direction mark DM can be displayed in a color, a line type, or the like different from that of the normal crop mark MK.

Note that the intermediate mark CM and the direction mark DM can be added to the printing area PA in accordance with the user's operation input. For example, in FIG. 13, a direction mark button 77b is provided in the setting input unit 72 on the output setting screen 70. The control unit 11 can add the direction mark DM to the printing area PA in accordance with the user's operation of the direction mark button 77b. Although not illustrated, similarly to the direction mark button 77b, a button for adding the intermediate mark CM can be provided in the setting input unit 72.

As described above, the cutting member 403 to be used is configured to be selected in addition to the cutting plotter 400 in the input field 73 (cf. FIG. 13) for the image forming apparatus 200 on the output setting screen 70. The control unit 11 can add a crop mark MK in accordance with the specifications of the selected cutting member 403. For example, the control unit 11 can change the orientation of the crop mark MK, change the shape, change the adding position, and the like in accordance with the selected cutting member 403.

Since the user does not need to understand the specifications of the cutting member 403 and perform detailed settings for the crop mark MK, the workload of the user can be reduced.

In the embodiment, an example has been described in which the addition setting for the crop mark MK is performed on the output setting screen 70. However, the control unit 11 may perform the addition setting for the crop mark MK on the design editing screen 30 (cf. FIG. 6) or the design placement form editing screen 50 (cf. FIG. 11). In this case, the setting input unit 72 can be provided in the design editing screen 30 or the design placement form editing screen 50.

As illustrated in FIG. 13, the output setting screen 70 is provided with an execution count input unit 78 and an output execution button 79. When the output setting on the output setting screen 70 is completed, the user inputs, in the execution count input unit 78, an execution count in the image forming apparatus 200, and clicks the output execution button 79 with the mouse or the like.

When the output execution button 79 is clicked, the control unit 11 performs an image data output process (FIG. 2, Step S04). Specifically, the control unit 11 converts the data file DFa or DFb for the design or the design placement form selected by the user into image data in a format in accordance with the specifications of the selected image forming apparatus 200.

For example, as illustrated in FIG. 9, when the object Ob9 for which “Print” has been input and the object Ob8 for which “Cut” has been input are mixed as processing content in the same design, the control unit 11 generates image data to be output to each of the printer 300 and the cutting plotter 400 (cf. FIG. 1).

The control unit 11 generates image data including the object Ob9 for the printer 300 and generates image data including the object Ob8 for the cutting plotter 400.

The control unit 11 outputs the generated image data to the corresponding image forming apparatus 200 along with a command such as an execution counts.

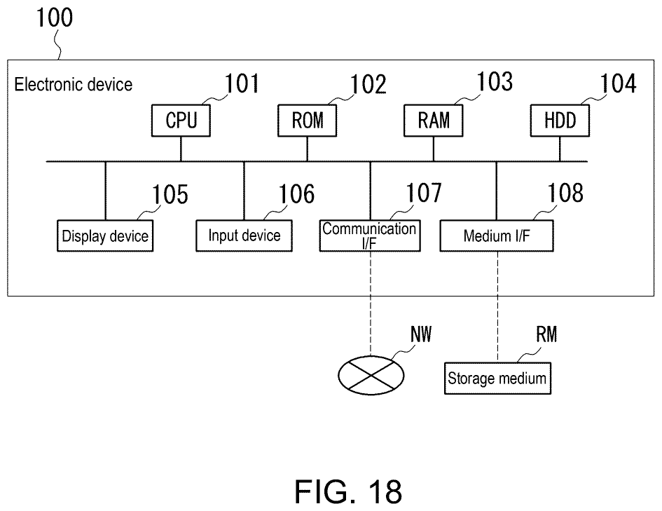

FIG. 18 is a diagram illustrating a hardware configuration of an electronic device 100 constituting the image processing apparatus 1.

As illustrated in FIG. 18, the electronic device 100 includes a central processing unit (CPU) 101, a read-only memory (ROM) 102, a random-access memory (RAM) 103, a hard disk drive (HDD) 104, a communication interface (I/F) 107, a media I/F 108, and the like. The respective components are mutually connected by a bus.

The CPU 101 is configured to control the entire electronic device 100. The CPU 101 can load an operation system (OS), various programs, and the like stored in the ROM 102 or the HDD 104 onto the RAM 103 and execute them. Alternatively, the CPU 101 can load a program stored in a storage medium RM onto the RAM 103 via the media I/F 108 and execute the program. The storage medium RM can be an optical storage medium, a magneto-optical storage medium, a magnetic storage medium, a conductor memory tape medium, a semiconductor memory, or the like.

Note that the electronic device 100 may include, as a processor, a graphics processing unit (GPU) or the like in addition to the CPU 101.

The electronic device 100 also includes a display device 105 (corresponding to the display unit 14 in FIG. 1) and an input device 106 (corresponding to the operation unit 13 in FIG. 1). The CPU 101 performs a process in accordance with the user's operation performed via the input device 106, and displays the result of the process on the display device 105.

The HDD 104 stores a program executed by the CPU 101, data used by the program, and the like. Note that a solid-state drive (SSD) may be provided instead of the HDD 104 or in addition to the HDD 104. The communication I/F 107 outputs data received from another device to the CPU 101 via a network NW such as the Internet or a local area network (LAN). The communication I/F 107 transmits data generated by the CPU 101 to another device. Another device can be, for example, the image forming apparatus 200 (cf. FIG. 1) or another electronic device. The CPU 101 may load a necessary program from another device onto the RAM 103 via the network NW.

In the present embodiment, the CPU 101 of the electronic device 100 functions as the control unit 11 of the image processing apparatus 1 illustrated in FIG. 1 by executing the application program loaded onto the RAM 103. In addition, the memories such as the ROM 102, the RAM 103, and the HDD 104 constitute the storage unit 12.

As described above, the image processing apparatus 1 described in the embodiment has, for example, the following configuration.

(1) The image processing apparatus 1 generates image data that can be output to the image forming apparatus 200.

The image processing apparatus 1 includes the control unit 11 that controls a screen caused to be displayed on the display unit 14 in accordance with the user's operation input via the operation unit 13.

The control unit 11 executes a home screen display process (step S01) of displaying the home screen 20 on the display unit 14.

The home screen 20 displays, in the display fields 21A, 21B, 21C, a design that can be used for image data, a form with which the design can be combined, and a design placement form obtained by combining the design and the form.

The home screen 20 displays the display fields 21A, 21B, 21C for the design, the form, and the design placement form side by side in the vertical direction (first direction), and displays the design placement form display field 21B between the design display field 21A and the form display field 21C in the vertical direction.

With such a configuration of the image processing apparatus 1, the user can easily visualize, from the home screen 20, a product in which a form and a design are combined.

The image processing apparatus 1 can easily generate various products by combining a design generated by the user with a form generated in advance. For example, the user can select a form to be used from a selection screen for displaying forms stored in the image processing apparatus 1. However, in the selection screen on which only a form is displayed, it is difficult for the user to visualize which design is to be combined with the form, and it is difficult to visualize what kind of product can be obtained when the design is combined with the form.

On the home screen 20, the image processing apparatus 1 according to the present embodiment displays, side by side, the display fields 21A, 21B, 21C for a design usable for image data, a form with which the design can be combined, and a design placement form obtained by combining the design and the form. This enables the user to understand at a glance from the home screen 20 what design and form can be used when image data is generated. Further, on the home screen 20, the display field 21C for the design placement form is displayed between the display fields 21A, 21C for the design and the form. This enables the user to select a design and a form to be used while specifically visualizing a product obtained by combining the design and the form.

(2) When the user selects the data file DFa, DFb, or DFc for the design, the form, or the design placement form displayed on the home screen 20, the control unit 11 causes the display unit 14 to display an editing screen (design editing screen 30, form editing screen 60, design placement form editing screen 50) on which the selected item can be edited.

This enables the user to smoothly move to the editing screen (design editing screen 30, form editing screen 60, design placement form editing screen 50) for each item by clicking the new generation button 22 or the data files DFa, DFb, or DFc from the display field 21A, 21B, or 21C on the home screen 20.

(3) The image processing apparatus 1 includes the storage unit 12 that stores the data files DFa, DFb, DFc for the design, the form, and the design placement form.

The home screen 20 displays the display fields 21A, 21B, 21C for displaying the data files DFa, DFb, DFc stored in the storage unit 12 for the respective items, which are the design, the form, and the design placement form.

In the display fields 21A, 21B, 21C, the data files DFa, DFb, DFc are displayed side by side in the horizontal direction (second direction) orthogonal to (intersecting) the vertical direction (first direction).

Since the data files DFa, DFb, DFc are displayed side by side in the display fields 21A, 21B, 21C, the user can understand at a glance from the home screen 20 what data files DFa, DFb, DFc are stored in the storage unit 12 for the respective items.

In the embodiment, an example has been described in which the first direction corresponds to the vertical direction and the second direction corresponds to the horizontal direction. However, the present disclosure is not limited to this example, and the first direction may be the horizontal direction and the second direction may be the vertical direction. In this case, the display fields 21A, 21B, 21C are displayed side by side in the vertical direction on the home screen 20.

The data files DFa, DFb, DFc are displayed side by side in the horizontal direction in the display fields 21A, 21B, 21C.

(4) The home screen 20 is configured to display at least one of a thumbnail, a file name, or last update time information for each of the data files DFa, DFb, DFc displayed in the display fields 21A, 21B, 21C.

Accordingly, when the display fields 21A, 21B, 21C display a plurality of data files DFa, DFb, DFc, information that can distinguish each of the data files DFa, DFb, DFc is displayed, so that the user can easily access the desired data files DFa, DFb, DFc.

(5) In the home screen display process, the control unit 11 is configured to extract or sort the data files DFa, DFb, DFc displayed in the display fields 21A, 21B, 21C in accordance with a condition specified by the user.

For example, the home screen 20 is provided with the sorting unit 25 that enables input of a condition for extraction or sorting. The user can specify a condition for extraction or sorting by operating the sorting unit 25.

In a case where a large number of data files DFa, DFb, DFc are stored in the image processing apparatus 1 or in other cases, the data files DFa, DFb, DFc are extracted or sorted, enabling the user to easily access the desired data files DFa, DFb, DFc.

For example, when the object Ob for which the cutting has been set is included in the data file DFa for the design DS, it may be difficult to distinguish based on the thumbnail. In such a case, the user can easily access the data file DFa by extracting the data file DFa that includes the object Ob for which the cutting has been set.

(6) The home screen 20 displays the calling mark 26 for the pop-up menu 27 in each of the display areas for the data files DFa, DFb, DFc of the display fields 21A, 21B, 21C.

In the home screen display process, the control unit 11 displays a process that can be executed on the data file DFa, DFb, or DFc as the pop-up menu 27 in accordance with the operation of the calling mark 26 by the user.

The home screen 20 displays the calling mark 26, enabling the user to easily access the pop-up menu 27. The user can easily specify a process to be performed on the data file DFa, DFb, or DFc from the pop-up menu 27 without operating the task bar TB or the like.

(7) When the duplication of the data file DFa, DFb, or DFc is selected in the pop-up menu 27, the control unit 11 duplicates and stores the selected data file DFa, DFb, or DFc in the storage unit 12, and causes the display unit 14 to display the editing screen (design editing screen 30, form editing screen 60, design placement form editing screen 50) on which the duplicated data file DFa, DFb, or DFc can be edited.

This enables the user to directly move to the editing screen for the duplicated data files DFa, DFb, or DFc to perform editing. The user does not need to reselect the duplicated file and display the editing screen, which is highly convenient.

(8) The control unit 11 is configured to causes the display unit 14 to display an item screen that displays only the data file DFa, DFb, or DFc for one item among the design DS, the form FM, and the design placement form in accordance with the user's operation input.

For example, when the number of data files DFa, DFb, DFc stored in the storage unit 12 exceeds the displayable number of the display fields 21A, 21B, 21C, the control unit 11 can cause the item screen calling unit 24 to be displayed on the home screen 20. By the user operating the calling unit 24, the control unit 11 can cause the item screen to be displayed.

When the user wishes to refer to the data file DFa, DFb, or DFc that were not fully displayed in the display fields 21A, 21B, 21C on the home screen 20, the user can easily access the desired data files DFa, DFb, DFc by operating the calling unit 24 to display the item screen.

(9) When the user selects the display field 21A, 21B, or 21C for one item among the design, the form, and the design placement form in the home screen display process, the control unit 11 causes the display field of the selected item to be displayed in a mode different from other display fields.

For example, when the user moves the pointer P of the mouse to an area overlapping one of the display field 21A, 21B, or 21C, the control unit 11 can cause that display field to be highlighted. The highlighting can include, for example, increasing the display size, imparting a floating effect, changing the background color, and the like.

The user can gaze at a desired display field while referring to the entire display fields 21A, 21B, 21C on the home screen 20. For example, while the display size of the design display field 21A is increased and the design to be used is examined, the form to be used can be examined together with reference to the display fields 21B, 21C, or the product can be visualized.

(10) In the home screen display process, when the user selects one of the data file DFa, DFb, or DFc displayed in the display field 21A, 21B, or 21C, the control unit 11 causes the selected data file DFa, DFb, or DFc to be displayed in a mode different from the other data files of the data files DFa, DFb, DFc.

For example, when the pointer P of the mouse or the like operated by the user overlaps one of the data files DFa in the display field 21A, the control unit 11 can cause that data file DFa to be highlighted. The highlighting can include, for example, increasing the display size, imparting a floating effect, surrounding with a frame, changing the background color, and the like.

As a result, the user can confirm details of the specific data file DFa, DFb, or DFc while referring to the various data files DFa, DFb, DFc on the home screen 20. For example, an increase in the display size of the selected data file DFa, DFb, or DFc causes the thumbnail to be displayed in a large size, thereby enabling details to be easily confirmed.

(11) When the user selects one of the data files DFb displayed in the design placement form display field 21B in the home screen display process, the control unit 11 causes the data files DFa, DFc for the design and the form, which are used in the data file DFb, to be displayed in a pickup display in the display fields 21A, 21C, respectively.

This enables the user to easily discern what design and form have been used to generate the selected design placement form. In particular, when the design placement form is obtained by combining a large number of designs or when a plurality of persons edit the design placement form, it may be difficult to understand, only with the thumbnail, what designs have been combined. In such a case as well, the pickup display enables the user to easily access the original data file DFa or DFc for the design or the form.

(12) When the user selects one of the data files DFa displayed in the design display field 21A in the home screen display process, the control unit 11 causes the data file DFb for the design placement form using the design of the data file DFa to be displayed in a pickup display in the design placement form display field 21B.

This enables the user to easily discern what design placement form the selected design has been used for. In particular, when the design placement form is obtained by combining a large number of designs or when a plurality of persons edit the design placement form, it may be difficult to understand, only with the thumbnail, what designs have been combined. In such a case as well, the pickup display enables the user to easily access the data file DFb for the design placement form using the selected design. For example, the user can use the pickup display when the user wishes to apply the editing content applied to the design also to the design placement form using the design.

(13) When the user requests to edit the design DS for use in the design placement form on the design placement form editing screen 50, the control unit 11 causes the design editing screen 30 to be displayed.

The control unit 11 stores the edited design DS in the storage unit 12 as a new data file DFa, and obtains the design placement form by combining the edited design DS.

For example, on the design placement form editing screen 50, the user can transition to the design editing screen 30 by double-clicking the design DS combined with the cell CL of the form FM with the mouse or by long-pressing the design DS with the finger in the case of the touch pad.

As a result, when the user needs to edit the design DS during editing of the design placement form, the user can directly transition to the design editing screen 30 without temporarily closing the design placement form editing screen 50. In addition, by storing the edited design DS in the storage unit 12 as a new data file DFa, the user can also use the edited design DS in other design placement forms, and thus there is no need to re-edit the design DS many times.

Note that the control unit 11 may transition from the design placement form editing screen 50 to the design editing screen 30, or may display the design editing screen 30 on a separate screen from the design placement form editing screen 50.

(I) The image processing apparatus 1 generates image data that can be output to the image forming apparatus 200.

The image processing apparatus 1 includes the control unit 11 that controls a screen caused to be displayed on the display unit 14 in accordance with the user's operation input via the operation unit 13.

The control unit 11 executes a preview screen display process (step S02) of displaying the design editing screen 30 (image data preview screen) on the display unit 14.

The design editing screen 30 includes the preview area 31, the object list 32, and the processing input unit 35.

The preview area 31 displays a preview of the objects Ob constituting the image data.

The object list 32 displays the object information 33 in a list format.

Processing content for each can be input into the processing input unit 35 for each object Ob.

With this configuration, processing content for each of the objects Ob constituting the image data can be easily set.

The image processing apparatus 1 generates image data to be output to the image forming apparatus 200 such as the printer 300. The image forming apparatus 200 can include the printer 300 that forms an image by printing, the cutting plotter 400 that forms an image by cutting, and the like.

When the object Ob to be printed by the printer 300, the object Ob to be cut by the cutting plotter 400, and the like are mixed in the same image data, the image processing apparatus 1 generates and outputs image data in accordance with the specifications of each of the printer 300 and the cutting plotter 400.

Therefore, the user needs to set processing content, such as printing or cutting, for each object Ob. Here, when the setting screen for processing content for the object Ob is provided as a separate screen from the preview screen, the user needs to transition the screen for each object Ob to set processing content, and the work becomes complicated.

The image processing apparatus 1 according to the present embodiment displays the preview area 31, the object list 32, and the processing input unit 35 on the same screen (design editing screen 30). The user can set processing content for each object Ob while referring to the preview area 31 and the object information 33. As a result, the workload of the user can be reduced. The user can set processing content while specifically visualizing the product by referring to the preview area 31.

(II) The image forming apparatus 200 can include a plurality of image forming apparatuses 200 (printer 300, cutting plotter 400, etc.) capable of executing different processes such as printing and cutting.

The processing input unit 35 is configured to receive, for each object Ob, processing content executable by each of the plurality of image forming apparatuses 200. The processing content can be, for example, “Print”, “Cut”, or the like.

The control unit 11 executes an image data output process (step S04) in which image data is generated for each processing content input to the processing input unit 35, and the image data is output to the image forming apparatus 200 capable of executing the corresponding processing content.

For example, the control unit 11 generates image data including the object Ob for which “Print” has been input as processing content and outputs the image data to the printer 300. For example, the control unit 11 generates image data including the object Ob for which “Cut” has been input as processing content, and outputs the image data to the cutting plotter 400.

When the objects Ob each having different processing content are mixed in the same design DS, the work becomes complicated if the user selects an object Ob for each processing content and generates the image data.

In the present embodiment, the control unit 11 generates image data to be output to the image forming apparatus 200 capable of executing processing content for each processing content input into the processing input unit 35. That is, the user only needs to designate processing content in the processing input unit 35, and the complexity of generating image data for each image forming apparatus 200 can be eliminated.

(III) A display process or a hide process in the preview area 31 for each object Ob can be input into the processing input unit 35. When “Hide” is input into the processing input unit 35, the control unit 11 can hide the object Ob in the preview area 31.

If the object Ob that is not subjected to printing or cutting remains in the preview area 31, it may be difficult for the user to specifically visualize the product. By switching the desired object Ob to a hidden state in the preview area 31, the user can perform the editing work while visualizing the product.

(IV) The image forming apparatus 200 can include, as an apparatus that forms an image by cutting, the cutting plotter 400 and the printer 300 that can perform both printing and cutting.

When cutting is input as processing content into the processing input unit 35, it becomes possible to input the cutting member 403 for use in cutting into the processing input unit 35.

Even when image data is output to the same cutting plotter 400, the format of the image data may change depending on the cutting member 403 to be used. Therefore, by enabling the cutting member 403, which is used in the processing input unit 35, to be input, the control unit 11 can generate image data corresponding to various cuttings.

(V) The image forming apparatus 200 can include a printer 300 as a device that forms an image by printing.

The control unit 11 can cause the display mode in the preview area 31 to differ between the object Ob for which the printing has been input as processing content into the processing input unit 35 and the object Ob for which the cutting has been input.

For example, when a large number of objects Ob are displayed in the preview area 31, it may be difficult to discern which object Ob is to be printed or cut, and there is a possibility that an input error or an input omission of processing content may occur in some objects Ob.

In the present embodiment, by changing the display mode of the object Ob between printing and cutting, the user can easily discern the processing content that has been input for each object Ob from the preview area 31, reducing input errors and input omissions of processing content.

(VI) The control unit 11 displays the object Ob for which the cutting has been input as processing content into the processing input unit 35 with a cut line in the preview area 31.

By displaying the object Ob for which the cutting has been input with a cut line, the user can edit the design DS while specifically visualizing the product.

The cut line may differ in line type, line thickness, line color, and the like from the line that displays the object Ob for which “Print” has been input. The cut line can be, for example, a broken line, a dotted line, a chain line, or the like. Alternatively, the cut line may be a solid line thinner than the object Ob for which “Print” has been input.

(VII) The control unit 11 changes the display color, in the preview area 31, of the object Ob for which the cutting has been input as processing content into the processing input unit 35.

For example, when the object Ob for which “Print” has been input is colored with the color to be printed, the control unit 11 can cause the object Ob, for which “Cut” has been input, to be displayed in an uncolored state. By displaying the object Ob, for which the cutting has been input, with a cut line in the uncolored state, the object Ob becomes close to an image of “Cut”, thereby making it easy for the user to intuitively understand the object Ob for which the cutting has been input.

(VIII) When the user selects one of objects Ob displayed in the preview area 31 in the preview screen display process, the control unit 11 is configured to change the display of the selected object Ob in the object list 32.

For example, the control unit 11 can surround the selected object Ob with a frame line F, change the display color, underline, and change the display size.

When the preview area 31 displays a plurality of objects Ob having similar shapes and colors, it may be difficult to discern correspondence with the objects Ob displayed in the preview area 31 based only on the information of the object list 32. By changing the display, in the object list 32, of the object Ob selected in the preview area 31, the user can easily understand the correspondence between the preview area 31 and the object list 32.

(IX) When the user selects one of the objects Ob displayed in the object list 32 in the preview screen display process, the control unit 11 is configured to change the display of the selected object Ob in the preview area 31.

For example, the control unit 11 can enclose the selected object Ob with a frame line F, display it in a blinking manner, or change its display color.

When the preview area 31 displays a plurality of objects Ob having similar shapes and colors, it may be difficult to discern correspondence with the objects Ob displayed in the preview area 31 based only on the information of the object list 32. By changing the display, in the preview area 31, of the object Ob selected in the object list 32, the user can easily understand the correspondence between the preview area 31 and the object list 32.

(X) In response to the user's request, the control unit 11 is configured to execute a filtering process of displaying, in the object list 32, only the objects Ob for which the same processing content has been input in the processing input unit 35.

For example, the control unit 11 causes the filtering icon ICd to be displayed on the design editing screen 30. When the user clicks the filtering icon ICd with the mouse or the like, the control unit 11 causes the display unit 14 to display an input field for inputting a filtering condition. The control unit 11 can perform filtering in accordance with a condition input by the user.

For example, when the design DS includes a large number of objects Ob, filtering by the user facilitates easier understanding of which processing content has been set for which object Ob.

(XI) In the filtering process, the control unit 11 causes only the filtered object Ob to be displayed in the preview area 31.

By reflecting the filtering result in the preview area 31 as well, the user can easily understand the group of the objects Ob for which the same processing content has been set.

(XII) The processing input unit 35 can be provided with the collective input unit 36 that can collectively input the same processing content for each of a plurality of objects Ob.

When the design DS includes a large number of objects Ob, the work of individually inputting processing content to each of the large number of objects Ob may become complicated. In that case, it is possible to reduce the complexity of the user's work by collectively setting processing content using the collective input unit 36.

(XIII) The objects Ob for which the same processing content is to be input can be selected in at least one of the object list 32 or the preview area 31.

For example, each object Ob displayed in the object list 32 can be provided with the check box 34 into which a check mark can be input. In addition, the collective input check box 34a can be provided to input check marks into all the check boxes 34.

Alternatively, the user can input a check mark into the corresponding check box 34 of the object list 32 by clicking the object Ob displayed in the preview area 31 with the mouse or the like, or by dragging to encompass a plurality of objects Ob.

The collective input unit 36 can collectively input processing content to the object Ob for which a check mark has been input into the check box 34.

The objects Ob to be collectively input can be selected in both the object list 32 and the preview area 31, whereby the convenience of the user can be improved.

(i) The image processing apparatus 1 generates image data that can be output to the image forming apparatus 200.

The image processing apparatus 1 includes the control unit 11 that controls a screen caused to be displayed on the display unit 14 in accordance with the user's operation input via the operation unit 13.

The control unit 11 performs a preview screen display process (step S02) of causing the display unit 14 to display the output setting screen 70 (image data preview screen), and a mark adding process (step S03) of adding the crop mark MK (alignment mark) to the printing area PA of the image data in accordance with the user's operation input on the output setting screen 70.

The output setting screen 70 includes the preview area 71 for displaying a preview of image data, and the setting input unit 72 (mark setting input unit) into which an addition setting for an alignment mark can be input.

In the setting field 77a, the setting input unit 72 can set whether the crop mark MK is to be added to the entire printing area PA or to each object OB within the printing area PA.

In the mark adding process, the control unit 11 causes the crop mark MK in accordance with addition setting in the setting input unit 72 to be displayed in the preview area 71.

With this configuration, the crop mark MK can be appropriately added in accordance with image data, thereby reducing printing errors and cutting errors.

In the image processing apparatus 1, for example, on the output setting screen 70, a mark adding process of adding the crop mark MK to the printing area PA of the image data to be output to the printer 300 can be performed.

Thus, the printer 300 can print the crop mark MK on the medium M along with the image. When the printed medium M is cut by the cutting plotter 400, the accuracy of cutting can be improved by performing alignment using the crop mark MK.

Here, if it is difficult to understand the positional relationship between the objects OB constituting the image data and the crop mark MK, there is a possibility that the crop mark MK is not appropriately added due to protrusion from the printing area PA, overlap with the object OB, or other factors.

In the present embodiment, the crop mark MK in accordance with the addition setting input by the setting input unit 72 is displayed in the preview area 71 on the output setting screen 70. This enables the user to understand the positional relationship between the objects OB constituting the image data and the crop mark MK, determine whether the crop mark MK has been appropriately added, and perform layout adjustment as necessary. As a result, printing errors and cutting errors of the crop mark MK can be reduced. In addition, since there is no need to provide more margin than necessary on the medium M so that the crop mark MK does not overlap the object OB, the degree of printing flexibility can be increased.

Moreover, in the setting field 77a of the setting input unit 72, it is possible to switch between adding the crop mark MK to the entire printing area PA or to each object OB constituting the design DS. The result of the switching in the setting field 77a is reflected in the preview area 71. This enables the user to easily attach the crop mark MK in an appropriate mode.

(ii, vi) In the mark adding process, the control unit 11 is configured to adjust the layout of the crop mark MK in the printing area PA and cause the crop mark MK to be displayed in the preview area 71 based on the information regarding at least one of the addition setting for the crop mark MK, the information 33 on the objects constituting the image data, the size of the crop mark MK, and the size of the medium M to be printed by the printer 300, which have been input into the setting input unit 72.

The control unit 11 automatically adjusts the layout of the crop mark MK, so that the user can add the crop mark MK to an appropriate position in the printing area PA without performing complicated addition setting. As a result, printing errors and cutting errors of the crop mark MK can be reduced. In addition, since there is no need to provide more margin than necessary on the medium M so that the crop mark MK does not overlap the object OB, the degree of printing flexibility can be increased.

Further, the user can confirm the crop mark MK after the layout adjustment displayed in the preview area 71 and perform further adjustment.

(iii) The preview screen can be at least one of the editing screens for image data (design editing screen 30, design placement form editing screen 50) or the output setting screen 70 for image data to the printer 300.

In the embodiment, an example in which the control unit 11 performs the mark adding process on the output setting screen 70 has been described. In this case, the user can also add the crop mark MK when outputting the generated design DS or design placement form to the printer 300 as image data.

Alternatively, the control unit 11 may provide the setting input unit 72 on the design editing screen 30 or the design placement form editing screen 50 to perform the mark adding process.

In this case, the user can generate the image data of the design DS or the design placement form while considering the addition of the crop mark MK.

(iv) Switching between displaying and hiding the alignment mark in the preview area 71 can be input into the setting input unit 72.

For example, the setting input unit 72 can be provided with the switch button 77c for displaying the crop mark MK. The control unit 11 can switch between displaying and hiding the crop mark MK in the preview area 71 in accordance with the user's operation of the switch button 77c.

In particular, when the crop mark MK is added on the design editing screen 30 or the design placement form editing screen 50, the user can easily perform the editing work by switching the crop mark MK to a hidden state as necessary.

(v) The control unit 11 is configured to change the size of the crop mark MK in accordance with the user's specification.

For example, the user can specify the size by dragging the crop mark MK displayed in the preview area 71 with the mouse or the like.

When the crop mark MK is increased in size, the improved positioning accuracy in the cutting plotter 400 can be expected. When the crop mark MK is reduced in size, it is possible to ensure a larger area in which the object OB is disposed in the printing area PA. The control unit 11 can respond to various needs of the user by changing the size of the crop mark MK in accordance with the user's needs.

(vii) The control unit 11 is configured to output an alert when at least a part of the crop mark MK exceeds the printing area PA of the image data.

The alert can be, for example, a text message, a voice, a warning sound, a warning light, or the like displayed on the output setting screen 70.

The alert makes it easier for the user to notice the protrusion of the crop mark MK, so that printing errors, cutting errors, and the like of the crop mark MK can be reduced.

(viii) When at least a part of the crop mark MK exceeds the printing area PA of the image data, the control unit 11 is configured to resize the crop mark MK.

For example, the control unit 11 can cause the automatic adjustment button 77d to be displayed with an alarm on the output setting screen 70. When the user clicks the automatic adjustment button 77d, the control unit 11 can perform resizing of the crop mark MK as layout adjustment.

As a result, the control unit 11 can add the crop mark MK in an appropriate size to the printing area PA without the user performing detailed adjustment work, thereby reducing printing errors.

(ix) Duplication conditions for the object OB in the image data are configured to be input into the input fields 75a, 75b, 75c of the setting input unit 72 (duplication condition input unit).

The duplication conditions can include, for example, an offset of the object OB from the origin O of the printing area PA, the number of copies (number of duplications), and a copy spacing (duplication spacing).

In the preview screen display process, the control unit 11 causes the object OB, duplicated based on the duplication condition, to be displayed in the preview area 71.

As described above, on the design placement form editing screen 50 (cf. FIG. 11), the design DS can be combined with the plurality of cells CL of the form FM to duplicate the design DS in various formats.

On the other hand, when the user simply wishes to duplicate and print the design DS, the user can easily duplicate the object OB by inputting the duplication condition on the output setting screen 70.

In particular, when the object OB duplicated and printed on the medium M is cut by the cutting plotter 400 or the like, the user can obtain a desired product by inputting a duplication condition in accordance with the specifications of the cutting plotter 400 into the setting input unit 72.

(x) In the mark adding process, the control unit 11 is configured to change the size of the crop mark MK based on the length of the printing area PA in the image data.

The length of the printing area PA corresponds to the length in the feed direction of the medium M in the printer 300 or the cutting plotter 400. As the feeding length of the medium M in the printer 300 or the cutting plotter 400 increases, the more likely misalignment is to occur, and thus, the required accuracy of the alignment using the crop mark MK becomes higher. For example, when the length of the printing area PA exceeds the predetermined length L, which is a guide that affects the accuracy of alignment, the control unit 11 can increase the size of the crop mark MK to improve the accuracy of alignment in the cutting plotter 400 and maintain the accuracy of cutting.

(xi) When the length of the printing area PA in the image data exceeds the predetermined length L in the mark adding process, the control unit 11 is configured to add the intermediate mark CM (alignment mark) to the intermediate portion of the printing area PA.

As described above, when the length of the printing area PA exceeds the predetermined length L, there is a possibility that the accuracy of alignment in the cutting plotter 400 is affected. Therefore, by adding the intermediate mark CM to the intermediate portion of the printing area PA, the accuracy of alignment can be improved and the accuracy of cutting can be maintained.

(xii) The control unit 11 is configured to cause the intermediate mark CM added to the intermediate portion to be displayed in a mode different from other alignment marks in the preview area 71. The intermediate mark CM can be displayed, for example, in a color, a line type, or the like different from that of the normal crop mark MK.

This enables the user to easily distinguish the automatically added intermediate mark CM from other alignment marks. For example, if the user does not need the intermediate mark CM, the intermediate mark CM may be deleted.

(xiii) The crop mark MK is configured to be used for alignment when cutting is performed after printing by the printer 300.

The cutting member 403 for use in cutting can be input into the setting input unit 72.

In the mark adding process, the control unit 11 adds the crop mark MK in accordance with cutting member 403.

By adding the crop mark MK in accordance with the cutting member 403, the accuracy of cutting can be further improved. In addition, it is not necessary for the user to understand the specifications of a plurality of cutting members 403 or perform fine adjustment, enabling reduction in workload.

(xiv) In the mark adding process, the control unit 11 is configured to add the direction mark DM indicating the feed direction of the medium M in the printer 300 or the cutting plotter 400 (the print direction of the image data) along with the crop mark MK.

When setting the medium M printed by the printer 300 on the cutting plotter 400, the user can easily understand the correct setting direction by referring to the direction mark DM.

The effect described above can also be applied to an image processing method performed by the image processing apparatus 1 and a program for causing the electronic device 100 to function as the image processing apparatus 1.

The present disclosure is not limited to the aspects of the embodiment and modifications described above, and can be appropriately modified within the scope of the technical idea of the present disclosure. The modifications may not only be applied to the embodiment, but at least some of the contents of each may also be applied to other modifications.

What is claimed is:

1. An image processing apparatus that generates image data outputtable to an image forming apparatus, the image processing apparatus comprising
a control unit that controls a screen caused to be displayed on a display unit in accordance with an operation input by a user via an operation unit,
wherein
the control unit executes a preview screen display process of causing the display unit to display a preview screen for the image data, and
the preview screen includes
a preview area that displays a preview of each of objects constituting the image data,
an object list that displays information on each of the objects in a list format, and
a processing input unit configured to allow processing content to be input for each of the objects.

2. The image processing apparatus according to claim 1, wherein
the image forming apparatus includes a plurality of image forming apparatuses capable of executing different processes,
the processing input unit is configured to receive, for each object, processing content executable by each of the plurality of image forming apparatuses, and
the control unit executes an image data output process in which image data is generated for each processing content input into the processing input unit, and the image data is output to the image forming apparatus capable of executing the corresponding processing content.

3. The image processing apparatus according to claim 1, wherein the processing input unit is configured to receive input of a process for displaying or hiding each of the objects in the preview area.

4. The image processing apparatus according to claim 2, wherein
the image forming apparatus includes an apparatus that forms an image by cutting, and
when the cutting is input as the processing content, the processing input unit is configured to receive input of a cutting member for use in the cutting.

5. The image processing apparatus according to claim 4, wherein
the image forming apparatus includes an apparatus that forms an image by printing, and
the control unit causes a display mode in the preview area to differ between an object for which the printing has been input as the processing content into the processing input unit and an object for which the cutting has been input.

6. The image processing apparatus according to claim 5, wherein the control unit displays the object for which the cutting has been input as the processing content into the processing input unit with a cut line in the preview area.

7. The image processing apparatus according to claim 5, wherein the control unit changes a display color in the preview area for the object for which the cutting has been input as the processing content into the processing input unit.

8. The image processing apparatus according to claim 6, wherein the control unit changes a display color in the preview area for the object for which the cutting has been input as the processing content into the processing input unit.

9. The image processing apparatus according to claim 1, wherein in the preview screen display process, when the user selects one of objects displayed in the preview area, the control unit changes display of the selected object in the object list.

10. The image processing apparatus according to claim 1, wherein in the preview screen display process, when the user selects one of the objects displayed in the object list, the control unit changes display of the selected object in the preview area.

11. The image processing apparatus according to claim 1, wherein in response to a request from the user, the control unit executes a filtering process of causing only objects, for which the same processing content has been input into the processing input unit, to be displayed in the object list.

12. The image processing apparatus according to claim 11, wherein in the filtering process, the control unit causes only filtered objects to be displayed in the preview area.

13. The image processing apparatus according to claim 1, wherein, the processing input unit is configured to allow the same processing content to be collectively input for a plurality of the objects.

14. The image processing apparatus according to claim 13, wherein the objects for which the same processing content is to be collectively input are selectable in at least one of the object list or the preview area.

15. An image processing method performed by an image processing apparatus that generates image data outputtable to an image forming apparatus,
wherein
the image forming apparatus includes a control unit that controls a screen caused to be displayed on a display unit in accordance with an operation input by a user via an operation unit,
the control unit executes a preview screen display process of causing the display unit to display a preview screen for the image data,
the preview screen includes
a preview area that displays a preview of each of objects constituting the image data,
an object list that displays information on each of the objects in a list format, and
a processing input unit configured to allow processing content to be input for each of the objects.

16. The image processing method according to claim 15, wherein
the image forming apparatus includes a plurality of image forming apparatuses capable of executing different processes,
the processing input unit is configured to receive, for each object, processing content executable by each of the plurality of image forming apparatuses, and
the control unit executes an image data output process of generating the image data for each type of the processing content input into the processing input unit and outputting the image data to the image forming apparatus capable of executing the processing content.

17. The image processing method according to claim 15, wherein a process of displaying or hiding each of the objects in the preview area is inputtable into the processing input unit.

18. The image processing method according to claim 16, wherein
the image forming apparatus includes a device that forms an image by cutting, and
when the cutting is input as the processing content, a cutting member for use in the cutting is inputtable into the processing input unit.

19. The image processing method according to claim 18, wherein
the image forming apparatus includes a device that forms an image by printing, and
the control unit causes a display mode in the preview area to differ between an object for which the printing has been input as the processing content into the processing input unit and an object for which the cutting has been input.

20. A non-transitory computer readable recording medium, storing a program that implements a function of an image processing apparatus that generates image data outputtable to an image forming apparatus, the program causing
an electronic device to function as a control unit that controls a screen caused to be displayed on a display unit in accordance with an operation input by a user via an operation unit, and
the control unit to execute a preview screen display process of causing the display unit to display a preview screen for the image data,
wherein the preview screen includes
a preview area that displays a preview of each of objects constituting the image data,
an object list that displays information on each of the objects in a list format, and
a processing input unit configured to allow processing content to be input for each of the objects.
